(19) United States
(12) Patent Application Publication
(10) Pub. No.: US 2022/0080403 A1
(43) Pub. Date: Mar. 17, 2022

(54) APPARATUSES, METHODS, AND SYSTEMS FOR IN-SITU SEALING OF REACTION CONTAINERS

(71) Applicant: BioFire Diagnostics, LLC, Salt Lake City, UT (US)

(72) Inventors: Charles W. McNall, Cottonwood Heights, UT (US); Michael A. Johnson, Millcreek, UT (US)

(21) Appl. No.: 17/415,846

(22) PCT Filed: Dec. 20, 2019
(86) PCT No.: PCT/US2019/067809

§ 371 Date: Jun. 18, 2021

Related U.S. Application Data
(60) Provisional application No. 62/783,269, filed on Dec. 21, 2018.

(51) Int. Cl. B01L 3/00; B01L 7/00; B32B 3/30; B32B 7/12; B32B 27/36

(52) U.S. Cl. CPC B01L 3/502; B01L 7/52; B32B 3/30; B32B 7/12; B32B 27/36; B01L 2300/044; B32B 2255/10; B01L 2200/12; B01L 2300/18; B01L 2300/123; B32B 2255/26; B32B 2255/24; B32B 2439/00; B01L 2200/0689

(57) ABSTRACT

Systems, methods, and apparatus are provided for in-situ sealing of reaction wells. This invention provides reaction containers, methods, and systems for in-situ sealing of individual reaction wells illustratively in a closed reaction container using the conditions already present in a reaction (e.g., a thermocycling reaction) to deform a sealing material to seal the reaction wells and create a seal that is present during the reaction and that remains after the reaction is complete.

### CROSS REFERENCE TO RELATED APPLICATION

This application claims the benefit of and priority to U.S. App. Ser. No. 62/783,269 filed Dec. 21, 2018, the entirety of which is incorporated herein by reference.

### BACKGROUND

In the United States, Canada, and Western Europe infectious disease accounts for approximately 7% of human mortality, while in developing regions infectious disease accounts for over 40% of human mortality. Infectious diseases lead to a variety of clinical manifestations. Among common overt manifestations are fever, pneumonia, meningitis, diarrhea, and diarrhea containing blood. While the physical manifestations suggest diseases caused by some pathogens and eliminate others as the etiological agent, a variety of potential causative agents remain, and clear diagnosis often requires a variety of assays be performed. Traditional microbiology techniques for identifying pathogens in clinical specimens can take days or weeks, often delaying a proper course of treatment.

In recent years, the polymerase chain reaction (PCR) has become a method of choice for rapid identification of infectious agents. PCR can be a rapid, sensitive, and specific tool to diagnose infectious disease. However, a challenge to using PCR as a primary means of diagnosis is the variety of possible causative organisms or viruses and the low levels of organism or virus present in some pathological specimens. It is often impractical to run large panels of PCR assays, one for each possible causative organism or virus, most of which are expected to be negative. The problem is exacerbated when pathogen nucleic acid is at low concentration and requires a large volume of sample to gather adequate reaction templates. In some cases, there is inadequate sample to assay for all possible etiological agents. A solution is to run “multiplex PCR” wherein the sample is concurrently assayed for multiple targets in a single reaction. While multiplex PCR has proved to be valuable in some systems, shortcomings exist concerning robustness of high level multiplex reactions and difficulties for clear analysis of multiple products. To solve these problems, the assay may be subsequently divided into multiple secondary PCRs. Nesting secondary reactions within the primary product increases robustness. Closed systems such as the FilmArray® (BioFire Diagnostics, LLC, Salt Lake City, Utah) reduce handling, thereby diminishing contamination risk.

Arrays of micro-wells included in the FilmArray® pouch provide a platform for multiple analytical tests to be performed on a small liquid sample. Appropriate sealing of the liquid inside each micro-well in this and other systems is needed to isolate the reaction and yield accurate results. A permanent seal may also be desirable to maintain well integrity to permit subsequent evaluation and analysis following the initial reaction period, illustratively for further analyses performed some time after the pouch is removed from the instrument. Pressure sensitive adhesives and heat sealing adhesives both present difficulties in performing this sealing function. Pressure sensitive adhesives risk premature adhesion and sealing of the micro-well openings prior to well filling. Heat sealing can also be problematic as the temperature sensitivity of the reagents in the reaction wells can prevent the use of an extra heating step to seal the wells. The present invention addresses various improvements relating to in-situ sealing of reaction wells using the conditions already present in thermocycling.

### BRIEF SUMMARY

Embodiments of the present disclosure solve one or more of the foregoing or other problems in the art. This invention provides reaction containers, methods, and systems for in-situ sealing of individual reaction wells illustratively in a closed reaction container using the conditions already present in a reaction (e.g., a thermocycling reaction) to deform a sealing material to seal the reaction wells and create a seal that is present during the reaction and that remains after the reaction is complete. Such sealable reaction containers, methods, and systems do not risk premature adhesion and sealing of the micro-well openings prior to well filling. Likewise, because the conditions needed for seal formation are already present in the normal reaction, the containers, methods, and systems described herein do not require an extra heating step for seal formation. Reaction wells sealed according to the methods and systems described herein can be preserved and re-read on the same or a different instrument. For example, such reaction wells can be used for comparing well-to-well variability or instrument-to-instrument variability. Also, reaction wells sealed according to the methods and systems described herein can be used for making a standard (e.g., a fluorescence standard) that can be used for calibrating instruments. Because the sealing material is included with the reaction container and there is little risk of premature seal formation, use of the sealable reaction containers and the methods and systems described herein may not require any special handling or sample preparation on the part of a user. While the embodiments described herein relate to in-situ sealing of reaction wells, one will appreciate that the principles and apparatuses described herein may be used for in-situ sealing of any portion of a reaction container, such as for in-situ sealing of reaction chambers (e.g., reaction blisters) or fluid channels.

Described herein are:

1. A method for in-situ sealing of a fluid sample in a plurality of reaction wells, comprising:

providing a reaction container comprising an array having a plurality of reaction wells, wherein the array is provided between a lower layer and an upper layer, the lower layer being bonded to a first end of the array to seal a first end of the reaction wells, and a second end of the array or an inner surface of the upper layer being provided with a sealing material for in-situ sealing of a second end of the reaction wells,

introducing a fluid sample into the reaction container such that each of the plurality of reaction wells is filled with a portion of the fluid sample, and

exposing the array to a reaction condition including heat and/or pressure to cause the sealing material to seal the second end of the reaction wells in-situ to substantially prevent flow of the fluid sample out of the plurality of reaction wells during or after exposure to the reaction condition.

2. The method of clause 1, wherein exposing the array to the reaction condition includes applying heat or pressure to the array, and wherein the reaction condition comprises substantially applying only heat or pressure to the array and no additional heat or pressure need be added in-situ to seal the second end of the reaction wells with the sealing material.

3. The method of one or more of clauses 1 or 2, wherein exposing the array to the reaction condition includes applying both heat and pressure to the array.

4. The method of one or more of clauses 1-3, wherein exposing the array to the reaction condition includes exposing the array to thermocycling conditions.

5. The method of one or more of clauses 1-4, wherein exposing the array to thermocycling conditions includes applying heat adjacent to the lower layer and applying pressure adjacent to the upper layer.

6. The method of one or more of clauses 1-5, wherein the upper layer is a flexible film layer that can be pressed against the array to seal a portion of the sample in each of the plurality of reaction wells.

7. The method of one or more of clauses 1-6, wherein the sealing material comprises a film layer bonded to the inner surface of the upper layer adjacent to the second end of the reaction wells, the film layer including a sealing material selected from the group consisting of a heat- and pressure-activated adhesive, a swelling material that swells in an aqueous environment, a wax, and combinations thereof, and the method further comprising bonding the sealing material under the reaction conditions to seal each of the plurality of reaction wells.

8. The method of one or more of clauses 1-7, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

9. The method of one or more of clauses 1-8, wherein the heat- and pressure-activated adhesive has a melting point in the range of about 60° C. to about 100° C. and exposing the array to the reaction condition includes deforming the sealing material, and wherein deforming the sealing material includes softening or at least partially melting the heat- and pressure-activated adhesive in-situ under thermocycling conditions to deform the heat- and pressure-activated adhesive into an opening of the plurality of reaction wells.

10. The method of one or more of clauses 1-9, wherein the array further comprises a pierced layer bonded to the second end of the array adjacent to the upper layer, the pierced layer having one or more piercings per reaction well, wherein the one or more piercings per reaction well allow the fluid sample to pass into each of the plurality of reaction wells but impede flow of the fluid sample back out of the reaction wells.

11. The method of one or more of clauses 1-10, wherein the pierced layer further comprises a sealing material selected from the group consisting of a heat- and pressure-activated adhesive, a swelling material that swells in an aqueous environment, an oil, a wax, and combinations thereof, and wherein the sealing material of the pierced layer deforms in-situ under the thermocycling conditions to seal each of the plurality of reaction wells.

12. The method of one or more of clauses 1-11, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

13. The method of one or more of clauses 1-12, wherein the array is provided in a closed reaction container that further includes:

a sample injection port for introducing the sample into the container,

a cell lysis zone configured for lysing cells, viruses, or spores located in the sample, the cell lysis zone fluidly connected to the sample injection port,

a nucleic acid preparation zone fluidly connected to the cell lysis zone, the nucleic acid preparation zone configured for purifying nucleic acids, and

a first-stage reaction zone fluidly connected to the nucleic acid preparation zone and the array, the first-stage reaction zone comprising a first-stage reaction blister configured for first-stage amplification of the sample,

wherein the cell lysis zone, the nucleic acid preparation zone, and the first stage reaction zoneare all provided within the closed reaction container, and

the method further comprises steps of:

injecting the fluid sample into the container via the sample injection port, and sealing the sample injection port subsequent to injecting the fluid sample,

introducing the fluid sample into the cell lysis zone and performing a cell lysis in the cell lysis zone to produce a cell lysate,

extracting nucleic acids from the cell lysate, and moving the extracted nucleic acids to the first-stage reaction zone,

subjecting the nucleic acids in the first-stage reaction zone to amplification conditions,

fluidly moving a portion of the nucleic acids from the first-stage reaction zone to each of the plurality of reaction wells of the array, and

performing a second-stage amplification in the plurality of reaction wells of the array.

14. The method of one or more of clauses 1-13, wherein the first-stage reaction zone includes a set of primers for PCR amplification of the nucleic acids in the fluid sample, and wherein each of the plurality of reaction wells of the array comprises a pair of primers for PCR amplification of a unique nucleic acid.

15. The method of one or more of clauses 1-14, wherein the seal is formed using heat and pressure supplied during or produced by the reaction condition, and wherein formation of the seal does not include a separate heating or pressure step.

16. A container for performing a plurality of reactions with a fluid sample, the container comprising:

an array having a plurality of reaction wells, wherein the array is provided between an upper layer and a lower layer, the lower layer being bonded to a first end of the array to seal a first end of the reaction wells, and

at least one of a second end of the array or the upper layer being provided with a sealing material for in-situ sealing of a second end of the reaction wells, wherein subsequent to providing the fluid sample into the plurality of reaction wells, and a reaction condition including heat and/or pressure causes the sealing material to seal the second end of the reaction wells to substantially prevent flow of the fluid sample out of the reaction wells.

17. The container of clause 16, wherein the reaction condition includes both heat and pressure applied to the array.

18. The container of one or more of clauses 16-17, wherein the reaction condition comprises substantially only heat or pressure applied to the array and no additional heat or pressure need be added in-situ to seal the reaction wells with the sealing material.

19. The container of one or more of clauses 16-18, wherein the reaction condition includes heat applied adjacent to the lower layer and pressure applied adjacent to the upper layer.

20. The container of one or more of clauses 16-19, wherein the heat and pressure are applied to the array during a thermocycling reaction.

21. The container of one or more of clauses 16-20, wherein the sealing material comprises a film layer bonded to the upper layer adjacent to the second end of the reaction wells, wherein the film layer bonded to the upper layer includes a sealing material selected from the group consisting of a heat- and pressure-activated adhesive, a swelling material that swells in an aqueous environment, a wax, and combinations thereof.

22. The container of one or more of clauses 16-21, wherein the heat- and pressure-activated adhesive or the wax at least partially softens or melts under thermocycling conditions to adhere to and substantially seal the second end of the reaction wells.

23. The container of one or more of clauses 16-22, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, hydrophilic gels or gelling agents, polyvinyl alcohol, polyvinyl acetate, co-polymers thereof, and combinations thereof.

24. The container of one or more of clauses 16-23, wherein the heat- and pressure-activated adhesive has a melting point in the range of about 60° C. to about 100° C.

25. The container of claim one or more of clauses 16-24, further comprising a pierced layer having one or more piercings per reaction well, the pierced layer being bonded to the array adjacent to the layer, wherein the one or more piercings extend through the pierced layer and are large enough to allow the fluid sample to pass into each of the plurality of reaction wells, but small enough to impede flow of the fluid sample back out of the reaction wells.

26. The container of one or more of clauses 16-25, wherein the pierced layer does not comprise the sealing material.

27. The container of one or more of clauses 16-26, wherein the pierced layer further comprises a sealing material selected from the group consisting of a heat- and pressure-activated adhesive, a swelling material that swells in an aqueous environment, an oil, a wax, and combinations thereof.

28. The container of one or more of clauses 16-27, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

29. The container of one or more of clauses 16-28, wherein each of the plurality of reaction wells comprises one or more reagents, wherein the reagents comprise one or more of a pair of PCR primers with each of the plurality of reaction wells being provided with a different pair of PCR primers, or a control nucleic acid and a pair of primers configured to amplify the control nucleic acid, and at least one other well contains the same primers but does not contain the control nucleic acid.

30. The container of one or more of clauses 16-29, wherein the array is provided in a closed system, the container further comprising

a sample injection port for introducing the sample into the container,

a cell lysis zone configured for lysing cells or spores located in the sample, the cell lysis zone fluidly connected to the sample injection port,

a nucleic acid preparation zone fluidly connected to the cell lysis zone, the nucleic acid preparation zone configured for purifying nucleic acids, and

a first-stage reaction zone fluidly connected to the nucleic acid preparation zone and the channel for receiving the fluid sample into the plurality of reaction wells, the first-stage reaction zone comprising a first-stage reaction blister configured for first-stage amplification of the sample, wherein the array is provided in a second-stage reaction zone, wherein each of the plurality of wells comprises components for further amplification of the sample.

31. The container of one or more of clauses 16-30, wherein the cell lysis zone, the nucleic acid preparation zone, and the first stage reaction zone are all provided within the closed system.

32. A container for performing a reaction with a fluid sample in a closed system, the container comprising:

a reaction zone comprising a stack of layers including an array layer having a plurality of reaction wells formed therein, a first outer layer bonded to the array layer to seal a first end of the reaction wells, a second outer layer disposed adjacent to a second end of the reaction wells opposite the first end of the reaction wells such that a fluid sample introduced into the reaction zone can flow into each of the reaction wells, and

a sealing layer bonded to the second outer layer disposed adjacent to the second end of the reaction wells or to a second end of the array layer adjacent to the second outer layer, wherein the sealing layer substantially seals the reaction wells in-situ under at least one of heat and pressure to prevent flow of the fluid sample back out of the reaction wells during or after the reaction.

33. The container of clause 32, wherein the sealing layer includes a sealing material selected from the group consisting of a heat- and pressure-activated adhesive, a swelling material that swells in an aqueous environment, a wax, and combinations thereof.

34. The container of one or more of clauses 32-33, wherein the heat- and pressure-activated adhesive and/or the wax at least softens and deforms under thermocycling conditions to substantially seal a second end of the reaction wells.

35. The container of one or more of clauses 32-34, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

36. The container of one or more of clauses 32-35, wherein the heat- and pressure-activated adhesive and/or the wax have a melting point in the range of about 60° C. to about 100° C.

37. The container of one or more of clauses 32-36, wherein the stack of layers of the reaction zone further comprises a pierced layer bonded to the array layer adjacent to the second outer layer, wherein the pierced layers has one or more piercings per reaction well and the one or more piercings extend through the pierced layer and are large enough to allow the fluid sample to pass into each of the plurality of reaction wells, but small enough to impede flow of the fluid sample back out of the reaction wells.

38. The container of one or more of clauses 32-37, wherein the pierced layer further comprises a sealing material selected from the group consisting of a heat- and pressure-activated adhesive, a swelling material that swells in an aqueous environment, an oil, a wax, and combinations thereof.

39. The container of one or more of clauses 32-38, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

40. The container of one or more of clauses 32-39 further comprising

a sample injection port for introducing the sample into the container,

a cell lysis zone configured for lysing cells or spores located in the sample, the cell lysis zone fluidly connected to the sample injection port,

a nucleic acid preparation zone fluidly connected to the cell lysis zone, the nucleic acid preparation zone configured for purifying nucleic acids, and

a first-stage reaction zone fluidly connected to the nucleic acid preparation zone and the reaction zone, the first-stage reaction zone comprising a first-stage reaction blister configured for first-stage amplification of the sample.

41. The container of one or more of clauses 32-40, wherein the cell lysis zone, the nucleic acid preparation zone, the first stage reaction zone, and the reaction zone are all provided within the closed system.

42. A thermocycling system, comprising a sample container for containing a fluid sample to be thermocycled, the sample container including:
a high density reaction zone comprising an array having a plurality of reaction wells, wherein the high density reaction zone is provided in a closed system between an upper layer and a lower layer, the lower layer being bonded to the array to seal one end of the reaction wells, and a sealing material for in-situ sealing of a second end of the reaction wells,
   wherein a fluid sample received in the high density reaction zone flows into each of the reaction wells, and
   wherein the sealing material deforms under thermocycling conditions to seal the second end of the reaction wells to substantially prevent flow of the fluid sample back out of the reaction wells,

an instrument configured to receive the sample container and subject the sample therein to thermocycling conditions, wherein the instrument includes:
a heater unit for thermocycling the fluid sample in the high density reaction zone between at least a first temperature and a second temperature at a cycle time, the sample container being received in the instrument with the lower layer adjacent to the heater unit,
a pressure transducer for compressing the high density reaction zone adjacent to the upper layer; and
a controller for controlling the heater unit and the pressure transducer.

43. The system of clause 42, wherein the controller includes one or both of an internal computing device or an external computing device.

44. The system of one or more of clauses 42-43, wherein the sample container is part of a closed reaction container having at least one additional fluidly connected sample container therein.

45. The system of one or more of clauses 42-44, wherein the controller is programmed to perform the method of one or more of clauses 1-15.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the invention. The features and advantages may be realized and obtained by means of the instruments and combinations particularly pointed out in the appended claims. These and other features will become more fully apparent from the following description and appended claims, or may be learned by the practice of the invention as set forth hereinafter.

### BRIEF DESCRIPTION OF THE DRAWINGS

FIG. 1 shows a flexible pouch useful for self-contained PCR.

FIG. 2 is an exploded perspective view of an instrument for use with the pouch of FIG. 1, including the pouch of FIG. 1.

FIG. 3 shows a partial cross-sectional view of the instrument of FIG. 2, including the bladder components of FIG. 2, with the pouch of FIG. 1.

FIG. 4 shows a motor used in one illustrative embodiment of the instrument of FIG. 2.

FIG. 5A illustrates a cross-sectional view of an embodiment of a high-density reaction zone of a reaction container with an in-situ sealing layer disposed on an inner surface of the upper outer layer.

FIG. 5B illustrates the high-density reaction zone if FIG. 5A with the in-situ seal formed to substantially seal the fluid samples in the high-density wells.

FIG. 6A illustrates a cross-sectional view of another embodiment of a high-density reaction zone of a reaction container wherein an in-situ sealing material is disposed on the high-density array.

FIG. 6B illustrates the high-density reaction zone if FIG. 6A with the in-situ seal formed to substantially seal the fluid samples in the high-density wells.

FIG. 7A illustrates a cross-sectional view of another embodiment of a high-density reaction zone of a reaction container wherein an in-situ sealing layer is disposed on an inner surface of the upper outer layer.

FIG. 7B illustrates the high-density reaction zone if FIG. 7A with the in-situ seal formed to substantially seal the fluid samples in the high-density wells.

FIG. 8A illustrates a cross-sectional view of another embodiment of a high-density reaction zone of a reaction container wherein an in-situ sealing material is associated with the high-density array.

FIG. 8B illustrates the high-density reaction zone if FIG. 8A with the in-situ seal formed to substantially seal the fluid samples in the high-density wells.

FIG. 9 illustrates a cross-sectional view of a film material that can be used to fabricate an in-situ sealing material.

FIGS. 10A-10C illustrate an embodiment of a thermocycling system that can be used for a reaction container that includes a high-density reaction zone and an in-situ sealing feature.

FIG. 10D illustrates a high-density reaction zone similar to that illustrated in FIGS. 7A and 7B after the in-situ seal has been formed in the thermocycling apparatus of FIGS. 10A-10C.

FIG. 11 illustrates time course experiment at several time points (in-process, 1 week, 3 weeks) for retention of a fluorescent material in the wells of high-density reaction zone with and without an in-situ sealing material.

### DETAILED DESCRIPTION

Example embodiments are described below with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity. Like reference numbers refer to like elements throughout the description.

Unless defined otherwise, all terms (including technical and scientific terms) used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. While a number of methods and materials similar or equivalent to those described herein can be used in the practice of the present disclosure, only certain exemplary materials and methods are described herein.

All publications, patent applications, patents or other references mentioned herein are incorporated by reference for in their entirety. In case of a conflict in terminology, the present specification is controlling.

Various aspects of the present disclosure, including devices, systems, methods, etc., may be illustrated with reference to one or more exemplary implementations. As used herein, the terms “exemplary” and “illustrative” mean “serving as an example, instance, or illustration,” and should not necessarily be construed as preferred or advantageous over other implementations disclosed herein. In addition, reference to an “implementation” or “embodiment” of the present disclosure or invention includes a specific reference to one or more embodiments thereof, and vice versa, and is intended to provide illustrative examples without limiting the scope of the invention, which is indicated by the appended claims rather than by the following description.

It will be noted that, as used in this specification and the appended claims, the singular forms “a,” “an,” and “the” include plural referents unless the content clearly dictates otherwise. Thus, for example, reference to “a tile” includes one, two, or more tiles. Similarly, reference to a plurality of referents should be interpreted as comprising a single referent and/or a plurality of referents unless the content and/or context clearly dictate otherwise. Thus, reference to “tiles” does not necessarily require a plurality of such tiles.

Instead, it will be appreciated that independent of conjugation; one or more tiles are contemplated herein.

Also, as used herein, “and/or” refers to and encompasses any and all possible combinations of one or more of the associated listed items, as well as the lack of combinations when interpreted in the alternative (“or”).

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” variants thereof (e.g., “includes,” “has,” “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

As used herein, directional and/or arbitrary terms, such as “top,” “bottom,” “left,” “right,” “up,” “down,” “upper,” “lower,” “inner,” “outer,” “internal,” “external,” “interior,” “exterior,” “proximal,” “distal,” “forward,” “reverse,” and the like can be used solely to indicate relative directions and/or orientations and may not be otherwise intended to limit the scope of the disclosure, including the specification, invention, and/or claims.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present.

Example embodiments of the present inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the present inventive concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

It is also understood that various implementations described herein can be utilized in combination with any other implementation described or disclosed, without departing from the scope of the present disclosure. Therefore, products, members, elements, devices, apparatuses, systems, methods, processes, compositions, and/or kits according to certain implementations of the present disclosure can include, incorporate, or otherwise comprise properties, features, components, members, elements, steps, and/or the like described in other implementations (including systems, methods, apparatus, and/or the like) disclosed herein without departing from the scope of the present disclosure. Thus, reference to a specific feature in relation to one implementation should not be construed as being limited to applications only within that implementation.

The headings used herein are for organizational purposes only and are not meant to be used to limit the scope of the description or the claims. To facilitate understanding, like reference numerals have been used, where possible, to designate like elements common to the figures. Furthermore, where possible, like numbering of elements have been used in various figures. Furthermore, alternative configurations of a particular element may each include separate letters appended to the element number.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 5%. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The word “or” as used herein means any one member of a particular list and also includes any combination of members of that list.

By “sample” is meant an animal; a tissue or organ from an animal; a cell (either within a subject, taken directly from a subject, or a cell maintained in culture or from a cultured cell line); a cell lysate (or lysate fraction) or cell extract; a solution containing one or more molecules derived from a cell, cellular material, or viral material (e.g., a polypeptide or nucleic acid); or a solution containing a non-naturally occurring nucleic acid, drugs or pharmaceuticals and drug process precursors (e.g., biologics, drugs, injectables, bioreactor components, etc.) which may be assayed as described herein. A sample may also be any body fluid or excretion (for example, but not limited to, blood, urine, stool, saliva, tears, bile, or cerebrospinal fluid) that may or may not contain host or pathogen cells, cell components, or nucleic acids. Samples may also include environmental samples such as, but not limited to, soil, water (fresh water, waste water, etc.), air monitoring system samples (e.g., material captured in an air filter medium), surface swabs, and vectors (e.g., mosquitos, ticks, fleas, etc.).

The phrase “nucleic acid” as used herein refers to a naturally occurring or synthetic oligonucleotide or polynucleotide, whether DNA or RNA or DNA-RNA hybrid, single-stranded or double-stranded, sense or antisense, which is capable of hybridization to a complementary nucleic acid by Watson-Crick base-pairing. Nucleic acids of the invention can also include nucleotide analogs (e.g., BrdU), and non-phosphodiester internucleoside linkages (e.g., peptide nucleic acid (PNA) or thiodiester linkages). In particular, nucleic acids can include, without limitation, DNA, RNA, mRNA, rRNA, cDNA, gDNA, ssDNA, dsDNA, or any combination thereof.

By “probe,” “primer,” or “oligonucleotide” is meant a single-stranded nucleic acid molecule of defined sequence that can base-pair to a second nucleic acid molecule that contains a complementary sequence (the “target”). The stability of the resulting hybrid depends upon the length, GC content, and the extent of the base-pairing that occurs. The extent of base-pairing is affected by parameters such as the degree of complementarity between the probe and target molecules and the degree of stringency of the hybridization conditions. The degree of hybridization stringency is affected by parameters such as temperature, salt concentration, and the concentration of organic molecules such as formamide, and is determined by methods known to one skilled in the art. Probes, primers, and oligonucleotides may be detectably-labeled, either radioactively, fluorescently, or non-radioactively, by methods well-known to those skilled in the art. dsDNA binding dyes may be used to detect dsDNA. It is understood that a “primer” is specifically configured to be extended by a polymerase, whereas a “probe” or “oligonucleotide” may or may not be so configured.

By “dsDNA binding dyes” is meant dyes that fluoresce differentially when bound to double-stranded DNA than when bound to single-stranded DNA or free in solution, usually by fluorescing more strongly. While reference is made to dsDNA binding dyes, it is understood that any suitable dye may be used herein, with some non-limiting illustrative dyes described in U.S. Pat. No. 7,387,887, herein incorporated by reference. Other signal producing substances may be used for detecting nucleic acid amplification and melting, illustratively enzymes, antibodies, etc., as are known in the art.

By “specifically hybridizes” is meant that a probe, primer, or oligonucleotide recognizes and physically interacts (that is, base-pairs) with a substantially complementary nucleic acid (for example, a sample nucleic acid) under high stringency conditions, and does not substantially base pair with other nucleic acids.

By “high stringency conditions” is meant typically to occur at about a melting temperature (Tm) minus 5° C. (i.e. 5° below the Tm of the probe). Functionally, high stringency conditions are used to identify nucleic acid sequences having at least 80% sequence identity.

As used herein, the term ‘canonical sequence’ (the term ‘consensus sequence’ is synonymous and also commonly used in the art) refers to the calculated order of most frequent nucleotide residues found at each position in a sequence alignment. The canonical sequence represents the results of multiple sequence alignments in which related sequences are compared to each other and similar sequence motifs are calculated. The panels referred to herein are often designed to detect a set of organisms. For each organism in a panel, the known variants of that organism typically have some sequence differences within the amplicons amplified by the panel. Thus, for most assays, it is generally not accurate to refer to one pathogen sequence because each pathogen in the panel represents a population of closely related sequence variants. Thus, the amplicons for a given organism represent all of the variants within the detected population—i.e., the canonical sequence. While the term ‘canonical sequence’ may be generally more accurate, the term ‘pathogen sequence’ is used synonymously herein. While many assays use a canonical sequence, some assays may use a native sequence, particularly where there is little variation between included strains for a particular target sequence. The term ‘canonical sequence’ is meant to include such sequences as well.

While PCR is the amplification method used in the examples herein, it is understood that any amplification method that uses a primer may be suitable. Such suitable procedures include polymerase chain reaction (PCR); strand displacement amplification (SDA); nucleic acid sequence-based amplification (NASBA); cascade rolling circle amplification (CRCA), loop-mediated isothermal amplification of DNA (LAMP); isothermal and chimeric primer-initiated amplification of nucleic acids (ICAN); target based-helicase dependent amplification (HDA); transcription-mediated amplification (TMA), and the like. Therefore, when the term PCR is used, it should be understood to include other alternative amplification methods. For amplification methods without discrete cycles, reaction time may be used where measurements are made in cycles, doubling time, or crossing point (Cp), and additional reaction time may be added where additional PCR cycles are added in the embodiments described herein. It is understood that protocols may need to be adjusted accordingly.

As used herein, the term “crossing point” (Cp) (or, alternatively, cycle threshold (Ct), quantification cycle (Cq), or a synonymous term used in the art) refers to the number of cycles of PCR required to obtain a fluorescence signal above some threshold value for a given PCR product (e.g., target or internal standard(s)), as determined experimentally. The cycle where each reaction rises above the threshold is dependent on the amount of target (i.e., reaction template) present at the beginning of the PCR reaction. The threshold value may typically be set at the point where the product's fluorescence signal is detectable above background fluorescence; however, other threshold values may be employed. As an alternative to setting a somewhat arbitrary threshold value, Cp may be determined by calculating the point for a reaction at which a first, second, or nth order derivative has its maximum value, which determines the cycle at which the curvature of the amplification curve is maximal. An illustrative derivative method was taught in U.S. Pat. No. 6,303,305, herein incorporated by reference in its entirety. Nevertheless, it usually does not matter much where or how the threshold is set, so long as the same threshold is used for all reactions that are being compared. Other points may be used as well, as are known in the art, and any such point may be substituted for Cp, Ct, or Cq in any of the methods discussed herein.

While various examples herein reference human targets and human pathogens, these examples are illustrative only. Methods, kits, and devices described herein may be used to detect and sequence a wide variety of nucleic acid sequences from a wide variety of samples, including, human, veterinary, industrial, and environmental. Furthermore, while nucleic acid amplification is discussed herein, the methods, kits, and devices described herein may be used for a wide variety of reactions using various vessels in need of in-situ sealing.

Various embodiments disclosed herein use a self-contained nucleic acid analysis pouch to assay a sample for the presence of various biological substances, illustratively antigens and nucleic acid sequences, illustratively in a single closed system. Such systems, including pouches and instruments for use with the pouches, are disclosed in more detail in U.S. Pat. Nos. 8,394,608; 8,895,295; and 10,464,060, herein incorporated by reference in their entireties. However, it is understood that such pouches are illustrative only, and the nucleic acid preparation and amplification reactions discussed herein may be performed in any of a variety of open or closed system sample vessels as are known in the art, including 96-well plates, plates of other configurations, arrays, carousels, and the like, using a variety of nucleic acid purification and amplification systems, as are known in the art.

While the terms “sample well”, “amplification well”, “amplification container”, “reaction chamber”, “reaction zone”, or the like are used herein, these terms are meant to encompass wells, tubes, and various other reaction containers, as are used in these amplification systems. In one embodiment, a pouch may be an assay device that includes one or more reaction containers or reaction zones. In one embodiment, a pouch may be a flexible container. For instance, a pouch/flexible container may include one or more sample wells, amplification wells, amplification containers, reaction chambers, reaction zones, or the like formed between two or more flexible layers of material. In one embodiment, the pouch is used to assay for multiple pathogens. The pouch may include one or more blisters used as sample wells, illustratively in a closed system. Illustratively, various steps may be performed in the optionally disposable pouch, including nucleic acid preparation, primary large volume multiplex PCR, dilution of primary amplification product, and secondary PCR, culminating with optional real-time detection or post-amplification analysis such as melting-curve analysis. Further, it is understood that while the various steps may be performed in pouches of the present invention, one or more of the steps may be omitted for certain uses, and the pouch configuration may be altered accordingly.

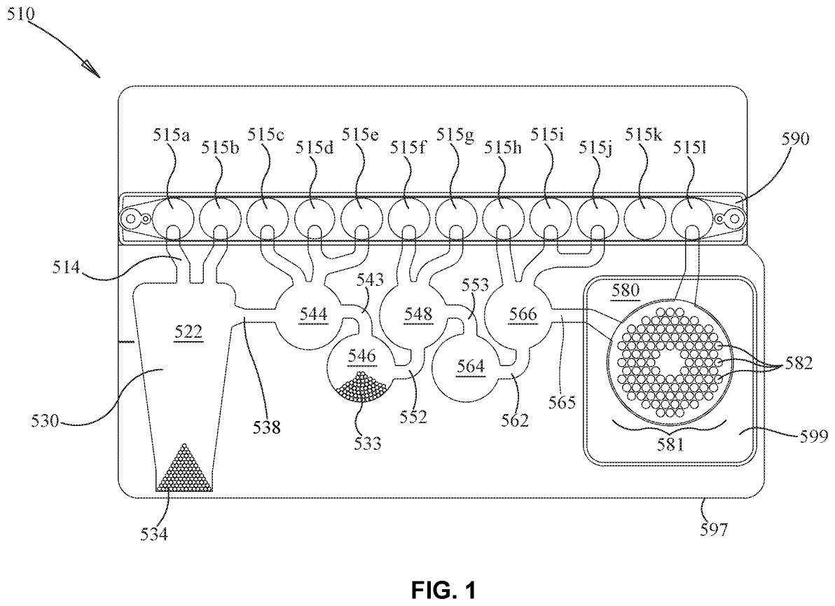

FIG. 1 shows an illustrative pouch 510 that may be used in various embodiments, or may be reconfigured for various embodiments. Pouch 510 is similar to FIG. 15 of U.S. Pat. No. 8,895,295, with like items numbered the same. Fitment 590 is provided with entry channels 515a through 515l, which also serve as reagent reservoirs or waste reservoirs. Illustratively, reagents may be freeze dried in fitment 590 and rehydrated prior to use. Blisters 522, 544, 546, 548, 564, and 566, with their respective channels 514, 538, 543, 552, 553, 562, and 565 are similar to blisters of the same number of FIG. 15 of U.S. Pat. No. 8,895,295. Second-stage reaction zone 580 of FIG. 1 is similar to that of U.S. Pat. No. 8,895,295, but the second-stage wells 582 of high density array 581 are arranged in a somewhat different pattern. The more circular pattern of high density array 581 of FIG. 1 eliminates wells in corners and may result in more uniform filling of second-stage wells 582. As shown, the high density array 581 is provided with 102 second-stage wells 582. Pouch 510 is suitable for use in the FilmArray® instrument (BioFire Diagnostics, LLC, Salt Lake City, Utah). However, it is understood that the pouch embodiment is illustrative only.

While other containers may be used, illustratively, pouch 510 may be formed of two layers of a flexible plastic film or other flexible material such as polyester, polyethylene terephthalate (PET), polycarbonate, polypropylene (PP), polymethylmethacrylate, mixtures, combinations, and layers thereof that can be made by any process known in the art, including extrusion, plasma deposition, and lamination. For instance, each layer can be composed of one or more layers of material of a single type or more than one type that are laminated together. One operative example is a bilayer plastic film that includes a PET layer and a PP layer. Metal foils or plastics with aluminum lamination also may be used. If plastic film is used, the layers may be bonded together, illustratively by laser welding and/or heat sealing. Illustratively, the material has low nucleic acid binding capacity. Similar materials (e.g., PET or polycarbonate) may be used for the high density array 581.

In some embodiments, a barrier film may be used in one or more of the layers used to form the flexible pouch 510. For instance, barrier films may be desirable for some applications because they have low water vapor and/or oxygen transmission rates that may be lower than conventional plastic films. For example, typical barrier films have water vapor transmission rates (WVTR) in a range of about 0.01 g/m²/24 hrs to about 3 g/m²/24 hrs, preferably in a range of about 0.05 g/m²/24 hrs to about 2 g/m²/24 hrs (e.g., no more than about 1 g/m²/24 hrs) and oxygen transmission rates in a range of about 0.01 cc/m²/24 hrs to about 2 cc/m²/24 hrs, preferably in a range of about 0.05 cc/m²/24 hrs to about 2 cc/m²/24 hrs (e.g., no more than about 1 cc/m²/24 hrs). Examples of barrier films include, but are not limited to, films that can be metallized by vapor deposition of a metal (e.g., aluminum or another metal) or sputter coated with an oxide (e.g., Al₂O₃ or SiOₓ) or another chemical composition. A common example of a metallized film is aluminized Mylar, which is metal coated biaxially oriented PET (BoPET). In some applications, coated barrier films can be laminated with a layer of polyethylene, PP, or a similar thermoplastic, which provides sealability and improves puncture resistance. As with conventional plastic films, barrier film layers used to fabricate a pouch may be bonded together, illustratively by heat sealing. Illustratively, the material has low nucleic acid binding and low protein binding capacity. Other barrier materials are known in the art that can be sealed together to form the blisters and channels.

For embodiments employing fluorescent monitoring, plastic films that are adequately low in absorbance and auto-fluorescence at the operative wavelengths are preferred. Such material could be identified by testing different plastics, different plasticizers, and composite ratios, as well as different thicknesses of the film. For plastics with aluminum or other foil lamination, the portion of the pouch that is to be read by a fluorescence detection device can be left without the foil. For example, if fluorescence is monitored in second-stage wells 582 of the second-stage reaction zone 580 of pouch 510, then one or both layers at wells 582 would be left without the foil. In the example of PCR, film laminates composed of polyester (Mylar, DuPont, Wilmington Del.) of about 0.0048 inch (0.1219 mm) thick and polypropylene films of 0.001-0.003 inch (0.025-0.076 mm) thick perform well. Illustratively, pouch 510 may be made of a clear material capable of transmitting approximately 80%-90% of incident light.

In one embodiment, the high-density array 581 and wells 582 are fabricated from a card material having a selected thickness such that the wells 582 formed in the card material have a selected volume. In one embodiment, the card material may be disposed between two or more flexible film layers that, respectively, seal one end of the array wells 582 and that form a channel or an open space that allow the wells 582 to be filled and then at least partially closed for performing a reaction in the high-density array. It is understood that while the pouch 510 is designed to be flexible, the high-density reaction zone 580 and the high-density array 581 optionally may be less flexible and may be rigid, and still be part of a flexible sample container. Thus, it is understood that a “flexible pouch” need only be flexible in certain zones.

In the illustrative embodiment, the materials are moved between blisters by the application of pressure by pressure actuators, illustratively pneumatic pressure actuators, upon the blisters and channels. Accordingly, in embodiments employing pressure, the pouch material illustratively is flexible enough to allow the pressure to have the desired effect. The term “flexible” is herein used to describe a physical characteristic of the material of the pouch. The term “flexible” is herein defined as readily deformable by the levels of pressure used herein without cracking, breaking, crazing, or the like. For example, thin plastic sheets, such as Saran™ wrap and Ziploc® bags, as well as thin metal foil, such as aluminum foil, are flexible. However, only certain regions of the blisters and channels need be flexible, even in embodiments employing pneumatic pressure. Further, only one side of the blisters and channels need to be flexible, as long as the blisters and channels are readily deformable. Other regions of the pouch 510 may be made of a rigid material or may be reinforced with a rigid material. Thus, it is understood that when the terms “flexible pouch” or “flexible sample container” or the like are used, only portions of the pouch or sample container need be flexible.

Illustratively, a plastic film may be used for pouch 510. A sheet of metal, illustratively aluminum, or other suitable material, may be milled or otherwise cut, to create a die having a pattern of raised surfaces. When fitted into a pneumatic press (illustratively A-5302-PDS, Janesville Tool Inc., Milton Wis.), illustratively regulated at an operating temperature of 195° C., the pneumatic press works like a printing press, melting the sealing surfaces of plastic film only where the die contacts the film. Likewise, the plastic film(s) used for pouch 510 may be cut and welded together using a laser cutting and welding device. Various components, such as PCR primers (illustratively spotted onto the film and dried), antigen binding substrates, magnetic beads, and zirconium silicate beads may be sealed inside various blisters as the pouch 510 is formed. Reagents for sample processing can be spotted onto the film prior to sealing, either collectively or separately. In one embodiment, nucleotide tri-phosphates (NTPs) are spotted onto the film separately from polymerase and primers, essentially eliminating activity of the polymerase until the reaction may be hydrated by an aqueous sample. If the aqueous sample has been heated prior to hydration, this creates the conditions for a true hot-start PCR and reduces or eliminates the need for expensive chemical hot-start components. In another embodiment, components may be provided in powder or pill form and are placed into blisters prior to final sealing.

Pouch 510 may be used in a manner similar to that described in U.S. Pat. No. 8,895,295. In one illustrative embodiment, a 300 μl mixture comprising the sample to be tested (100 μl) and lysis buffer (200 μl) may be injected into an injection port (not shown) in fitment 590 near entry channel 515a, and the sample mixture may be drawn into entry channel 515a. Water may also be injected into a second injection port (not shown) of the fitment 590 adjacent entry channel 515l, and is distributed via a channel (not shown) provided in fitment 590, thereby hydrating up to eleven different reagents, each of which were previously provided in dry form at entry channels 515b through 515l. Illustrative methods and devices for injecting sample and hydration fluid (e.g. water or buffer) are disclosed in U.S. Pat. No. 10,464,060, already incorporated by reference, although it is understood that these methods and devices are illustrative only and other ways of introducing sample and hydration fluid into pouch 510 are within the scope of this disclosure. These reagents illustratively may include freeze-dried PCR reagents, DNA extraction reagents, wash solutions, immunoassay reagents, or other chemical entities. Illustratively, the reagents are for nucleic acid extraction, first-stage multiplex PCR, dilution of the multiplex reaction, and preparation of second-stage PCR reagents, as well as control reactions. In the embodiment shown in FIG. 1, all that need be injected is the sample solution in one injection port and water in the other injection port. After injection, the two injection ports may be sealed. For more information on various configurations of pouch 510 and fitment 590, see U.S. Pat. No. 8,895,295, already incorporated by reference.

After injection, the sample may be moved from injection channel 515a to lysis blister 522 via channel 514. Lysis blister 522 is provided with beads or particles 534, such as ceramic beads or other abrasive elements, and is configured for vortexing via impaction using rotating blades or paddles provided within the FilmArray® instrument. Bead-milling, by shaking, vortexing, sonicating, and similar treatment of the sample in the presence of lysing particles such as zirconium silicate (ZS) beads 534, is an effective method to form a lysate. It is understood that, as used herein, terms such as “lyse,” “lysing,” and “lysate” are not limited to rupturing cells, but that such terms include disruption of non-cellular particles, such as viruses.

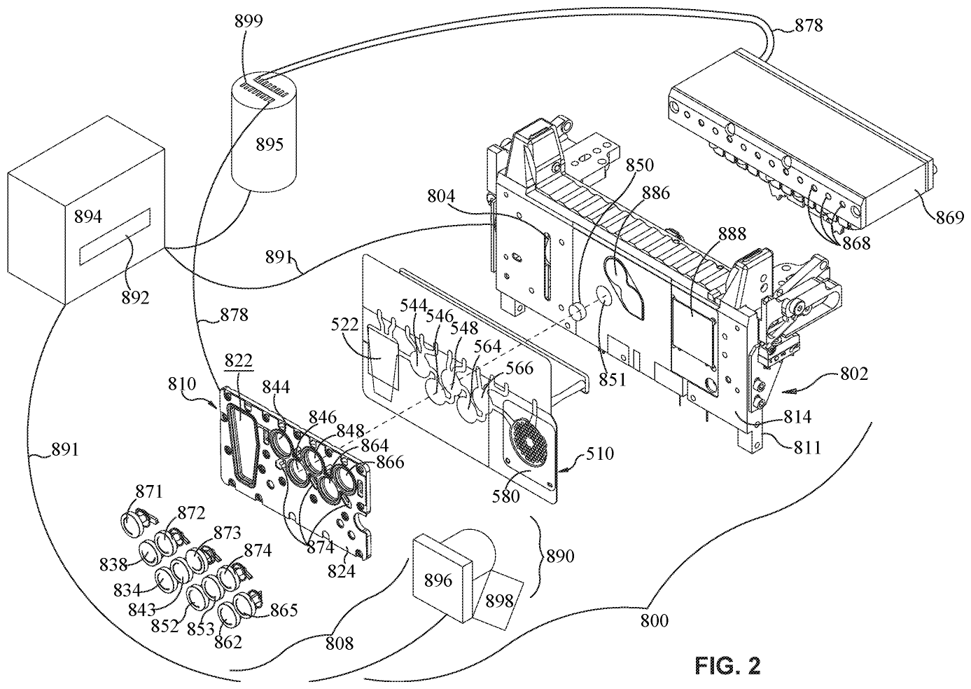

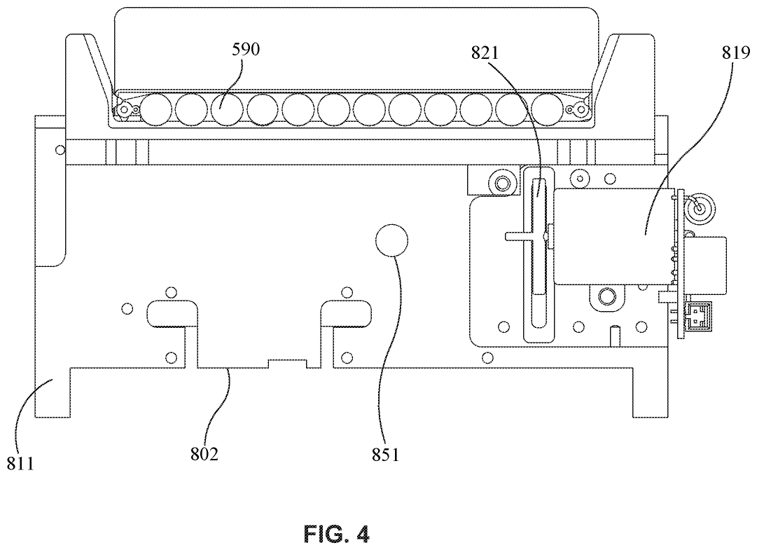

FIG. 4 shows a bead beating motor 819, comprising blades 821 that may be mounted on a first side 811 of support member 802, of instrument 800 shown in FIG. 2. Blades may extend through slot 804 to contact pouch 510. It is understood, however, that motor 819 may be mounted on other structures of instrument 800. In one illustrative embodiment, motor 819 is a Mabuchi RC-280SA-2865 DC Motor (Chiba, Japan), mounted on support member 802. In one illustrative embodiment, the motor is turned at 5,000 to 25,000 rpm, more illustratively 10,000 to 20,000 rpm, and still more illustratively approximately 15,000 to 18,000 rpm. For the Mabuchi motor, it has been found that 7.2V provides sufficient rpm for lysis. It is understood, however, that the actual speed may be somewhat slower when the blades 821 are impacting pouch 510. Other voltages and speeds may be used for lysis depending on the motor and paddles used. Optionally, controlled small volumes of air may be provided into the bladder 822 adjacent lysis blister 522. It has been found that in some embodiments, partially filling the adjacent bladder with one or more small volumes of air aids in positioning and supporting lysis blister during the lysis process. Alternatively, other structure, illustratively a rigid or compliant gasket or other retaining structure around lysis blister 522, can be used to restrain pouch 510 during lysis. It is also understood that motor 819 is illustrative only, and other devices may be used for milling, shaking, or vortexing the sample. In some embodiments, chemicals or heat may be used in addition to or instead of mechanical lysis.

Once the sample material has been adequately lysed, the sample is moved to a nucleic acid extraction zone, illustratively through channel 538, blister 544, and channel 543, to blister 546, where the sample is mixed with a nucleic acid-binding substance, such as silica-coated magnetic beads 533. Alternatively, magnetic beads 533 may be rehydrated, illustratively using fluid provided from one of the entry channel 515c-515e, and then moved through channel 543 to blister 544, and then through channel 538 to blister 522. The mixture is allowed to incubate for an appropriate length of time, illustratively approximately 10 seconds to 10 minutes. A retractable magnet located within the instrument adjacent blister 546 captures the magnetic beads 533 from the solution, forming a pellet against the interior surface of blister 546. If incubation takes place in blister 522, multiple portions of the solution may need to be moved to blister 546 for capture. The liquid is then moved out of blister 546 and back through blister 544 and into blister 522, which is now used as a waste receptacle. One or more wash buffers from one or more of injection channels 515c to 515e are provided via blister 544 and channel 543 to blister 546. Optionally, the magnet is retracted and the magnetic beads 533 are washed by moving the beads back and forth from blisters 544 and 546 via channel 543. Once the magnetic beads 533 are washed, the magnetic beads 533 are recaptured in blister 546 by activation of the magnet, and the wash solution is then moved to blister 522. This process may be repeated as necessary to wash the lysis buffer and sample debris from the nucleic acid-binding magnetic beads 533.

After washing, elution buffer stored at injection channel 515f is moved to blister 548, and the magnet is retracted. The solution is cycled between blisters 546 and 548 via channel 552, breaking up the pellet of magnetic beads 533 in blister 546 and allowing the captured nucleic acids to dissociate from the beads and come into solution. The magnet is once again activated, capturing the magnetic beads 533 in blister 546, and the eluted nucleic acid solution is moved into blister 548.

First-stage PCR master mix from injection channel 515g is mixed with the nucleic acid sample in blister 548. Optionally, the mixture is mixed by forcing the mixture between 548 and 564 via channel 553. After several cycles of mixing, the solution is contained in blister 564, where a pellet of first-stage PCR primers is provided, at least one set of primers for each target, and first-stage multiplex PCR is performed. If RNA targets are present, an RT step may be performed prior to or simultaneously with the first-stage multiplex PCR. First-stage multiplex PCR temperature cycling in the FilmArray® instrument is illustratively performed for 15-20 cycles, although other levels of amplification may be desirable, depending on the requirements of the specific application. The first-stage PCR master mix may be any of various master mixes, as are known in the art. In one illustrative example, the first-stage PCR master mix may be any of the chemistries disclosed in U.S. Pat. No. 9,932,634, herein incorporated by reference in its entirety, for use with PCR protocols taking 20 seconds or less per cycle.

After first-stage PCR has proceeded for the desired number of cycles, the sample may be diluted, illustratively by forcing most of the sample back into blister 548, leaving only a small amount in blister 564, and adding second-stage PCR master mix from injection channel 515i. Alternatively, a dilution buffer from 515i may be moved to blister 566 then mixed with the amplified sample in blister 564 by moving the fluids back and forth between blisters 564 and 566. If desired, dilution may be repeated several times, using dilution buffer from injection channels 515j and 515k, or injection channel 515k may be reserved, illustratively, for sequencing or for other post-PCR analysis, and then adding second-stage PCR master mix from injection channel 515h to some or all of the diluted amplified sample. It is understood that the level of dilution may be adjusted by altering the number of dilution steps or by altering the percentage of the sample discarded prior to mixing with the dilution buffer or second-stage PCR master mix comprising components for amplification, illustratively a polymerase, dNTPs, and a suitable buffer, although other components may be suitable, particularly for non-PCR amplification methods. If desired, this mixture of the sample and second-stage PCR master mix may be pre-heated in blister 564 prior to movement to second-stage wells 582 for second-stage amplification. Such preheating may obviate the need for a hot-start component (antibody, chemical, or otherwise) in the second-stage PCR mixture.

The illustrative second-stage PCR master mix is incomplete, lacking primer pairs, and each of the 102 second-stage wells 582 is pre-loaded with a specific PCR primer pair. If desired, second-stage PCR master mix may lack other reaction components, and these components may be pre-loaded in the second-stage wells 582 as well. Each primer pair may be similar to or identical to a first-stage PCR primer pair or may be nested within the first-stage primer pair. Movement of the sample from blister 564 to the second-stage wells 582 completes the PCR reaction mixture. Once high density array 581 is filled, the individual second-stage reactions are sealed in their respective second-stage blisters by any number of means, as is known in the art. Illustrative ways of filling and sealing the high density array 581 without cross-contamination are discussed in U.S. Pat. No. 8,895,295, already incorporated by reference. Illustratively, the various reactions in wells 582 of high density array 581 are simultaneously or individually thermal cycled, illustratively with one or more Peltier devices, although other means for thermal cycling are known in the art.

In certain embodiments, second-stage PCR master mix contains the dsDNA binding dye LCGreen® Plus (BioFire Diagnostics, LLC) to generate a signal indicative of amplification. However, it is understood that this dye is illustrative only, and that other signals may be used, including other dsDNA binding dyes and probes that are labeled fluorescently, radioactively, chemiluminescently, enzymatically, or the like, as are known in the art. Alternatively, wells 582 of array 581 may be provided without a signal, with results reported through subsequent processing.

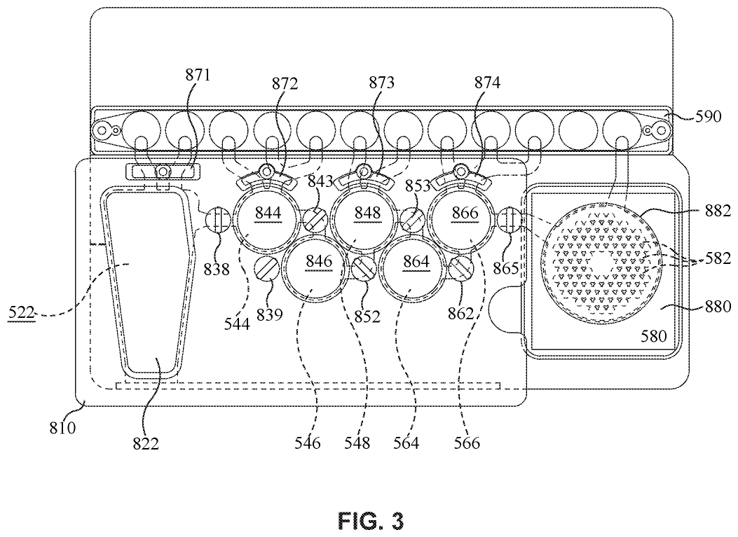

When pressure applied to the pouch blisters is used to move materials within pouch 510, in one embodiment, a pneumatic “bladder” may be employed. In other embodiments, a variety of mechanically driven pressure actuators may be used. The bladder assembly 810, a portion of which is shown in FIGS. 2-3, includes a bladder plate 824 housing a plurality of inflatable bladders 822, 844, 846, 848, 864, and 866, each of which may be individually inflatable, illustratively by a compressed gas source. Because the bladder assembly 810 may be subjected to compressed gas and used multiple times, the bladder assembly 810 may be made from tougher or thicker material than the pouch. Alternatively, bladders 822, 844, 846, 848, 864, and 866 may be formed from a series of plates fastened together with gaskets, seals, valves, and pistons. Other arrangements are within the scope of this invention. Alternatively, an array or mechanical actuators and seals may be used to seal channels and direct movement of fluids between blisters. A system of mechanical seals and actuators that may be adapted for the instruments described herein is described in detail in WO 2018/022971, the entirety of which is incorporated herein by reference.

Success of the secondary PCR reactions is dependent upon template generated by the multiplex first-stage reaction. Typically, PCR is performed using DNA of high purity. Methods such as phenol extraction or commercial DNA extraction kits provide DNA of high purity. Samples processed through the pouch 510 may require accommodations be made to compensate for a less pure preparation. PCR may be inhibited by components of biological samples, which is a potential obstacle. Illustratively, hot-start PCR, higher concentration of Taq polymerase enzyme, adjustments in MgCl₂ concentration, adjustments in primer concentration, and addition of adjuvants (such as DMSO, TMSO, or glycerol) optionally may be used to compensate for lower nucleic acid purity. While purity issues are likely to be more of a concern with first-stage amplification, it is understood that similar adjustments may be provided in the second-stage amplification as well.

When pouch 510 is placed within the instrument 800, the bladder assembly 810 is pressed against one face of the pouch 510, so that if a particular bladder is inflated, the pressure will force the liquid out of the corresponding blister in the pouch 510. In one or more embodiments, one or inflatable bladders may be inflated in the instrument to enhance contact between a blister one or more components of the instrument. For instance, pneumatic bladder 822 may be at least partially inflated to enhance contact between blister 522 on one side and a lysis apparatus on the other side. In another instance, pneumatic bladders 848 and 864 may be at least partially inflated over blisters 548 and 564 to enhance contact between blisters 548 and 564 and a heater assembly for first-stage PCR. In addition to bladders corresponding to many of the blisters of pouch 510, the bladder assembly 810 may have additional pneumatic actuators, such as bladders or pneumatically-driven pistons, corresponding to various channels of pouch 510. FIGS. 2-3 show an illustrative plurality of pistons or hard seals 838, 843, 852, 853, and 865 that correspond to channels 538, 543, 553, and 565 of pouch 510, as well as seals 871, 872, 873, 874 that minimize backflow into fitment 590. When activated, hard seals 838, 843, 852, 853, and 865 form pinch valves to pinch off and close the corresponding channels. To confine liquid within a particular blister of pouch 510, the hard seals are activated over the channels leading to and from the blister, such that the actuators function as pinch valves to pinch the channels shut. Illustratively, to mix two volumes of liquid in different blisters, the pinch valve actuator sealing the connecting channel is activated, and the pneumatic bladders over the blisters are alternately pressurized, forcing the liquid back and forth through the channel connecting the blisters to mix the liquid therein. The pinch valve actuators may be of various shapes and sizes and may be configured to pinch off more than one channel at a time.

While pneumatic actuators are discussed herein, it is understood that other types of pressure transducers that may be used for providing pressure to the pouch are contemplated, including various electromechanical actuators such as linear stepper motors, motor-driven cams, rigid paddles driven by pneumatic, hydraulic or electromagnetic forces, rollers, rocker-arms, and in some cases, cocked springs. In addition, there are a variety of methods of reversibly or irreversibly closing channels in addition to applying pressure normal to the axis of the channel. These include kinking the bag across the channel, heat-sealing, rolling an actuator, and a variety of physical valves sealed into the channel such as butterfly valves and ball valves. Additionally, small Peltier devices or other temperature regulators may be placed adjacent the channels and set at a temperature sufficient to freeze the fluid, effectively forming a seal. Also, while the pouch design of FIG. 1 is adapted for an automated instrument featuring actuator elements positioned over each of the blisters and channels, it is also contemplated that the actuators could remain stationary, and the pouch 510 could be transitioned such that a small number of actuators could be used for several of the processing stations including sample disruption, nucleic-acid capture, first and second-stage PCR, and processing stations for other applications of the pouch 510 such as immuno-assay and immuno-PCR. Rollers acting on channels and blisters could prove particularly useful in a configuration in which the pouch 510 is translated between stations. Thus, while pneumatic actuators are used in the presently disclosed embodiments, when the term “pneumatic actuator” is used herein, it is understood that other pressure transducers, actuators, and other ways of providing pressure may be used, depending on the configuration of the pouch and the instrument.

In addition to the foregoing pneumatic bladders and seals, FIG. 3 illustrates a configuration for another pressure transducer 880 that may be sized and positioned to apply pressure to the high-density reaction zone 580 and the high-density reaction wells 582. The pressure transducer 880 may be sized and positioned to apply pressure generally to the high-density reaction zone 580, or the pressure transducer 880 may be or include a substructure 882 that is sized and positioned to apply pressure just to the high-density reaction wells 582. In one embodiment, actuation of the pressure transducer 880 has the effect of pressing the high-density reaction zone 580 and the high-density reaction wells 582 gently against the second-stage PCR heater (888 in FIG. 2) to heat transfer from the heater 888 to the fluid in the reaction wells 582. In another embodiment, actuation of the pressure transducer 880 over the high-density reaction zone 580 or the high-density reaction wells 582 can compress the flexible layers 599 and 597 above and below the high-density reaction wells 582 to seal the wells shut and to clear excess fluid from the high-density reaction zone 580.

The pressure transducer 880 may be mechanically or pneumatically actuated, as described in detail herein above. Where fluorescent excitation of and detection from the high-density reaction wells 582 is desired, the pressure transducer 880 may include a clear plastic bladder or the like that may be inflated over the high-density reaction wells 582 after they are filled with a reaction mixture. In this case, pressure transducer 880 may include a “window bladder” that inflates over the high-density reaction wells 582 while allowing excitation light from light source 898 (FIG. 2) through for excitation of fluorescence and allowing observation by camera 896 (FIG. 2). As such, in embodiments using fluorescence or other optical detection, it is preferable that the pressure transducer 880 be fabricated from a material that is optically transparent and minimally fluorescent. A number of such materials are known in the art.

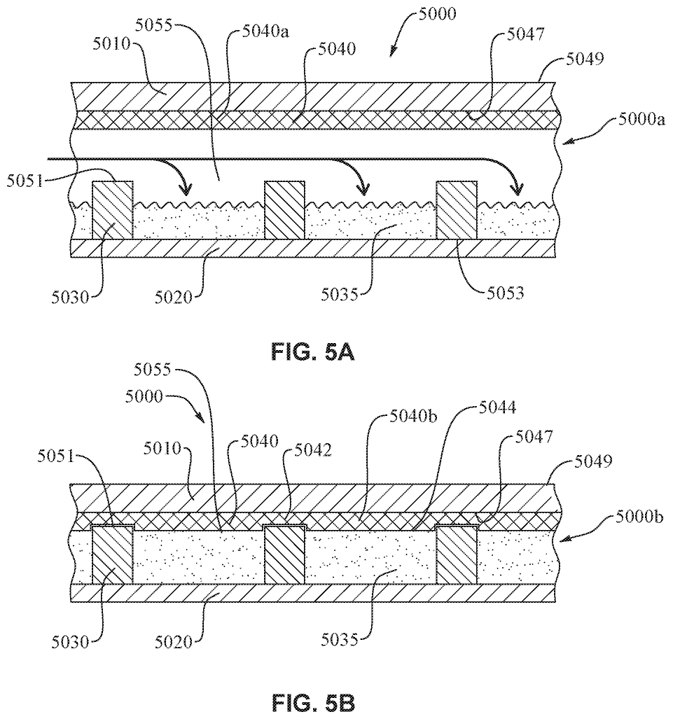

Likewise, in addition to the foregoing, in one embodiment the pressure transducer 880 can also efficiently and effectively clear excess fluid from the high-density reaction wells 582. For instance, clearing excess fluid from the second-stage array can lower PCR cycle time (i.e., smaller volumes of liquid can be cycled more quickly). Moreover, clearing excess fluid can help suppress intermixing between adjacent wells of the second-stage PCR array (referred to generally herein as ‘cross talk’). As discussed in U.S. Pat. No. 8,895,295, which was already incorporated by reference herein, the second-stage array may be provided with a pierced overlay that allows filling of the second-stage wells and that helps to suppress cross talk. Upon completion of the reaction, pressure may be reduced on high-density reaction zone 580 to allow removal from instrument 800. In an embodiment where no further analysis is needed, prevention of cross-talk between wells 582 is no longer necessary. Where further analysis is desirable, a more permanent sealing mechanism, illustratively any of the sealing layers described in conjunction with FIGS. 5-10, may be used.

Turning back to FIG. 2, each pneumatic actuator is connected to compressed air source 895 via valves 899. While only several hoses 878 are shown in FIG. 2, it is understood that each pneumatic fitting is connected via a hose 878 to the compressed gas source 895. Compressed gas source 895 may be a compressor, or, alternatively, compressed gas source 895 may be a compressed gas cylinder, such as a carbon dioxide cylinder. Compressed gas cylinders are particularly useful if portability is desired. Other sources of compressed gas are within the scope of this invention. Similar pneumatic control may be provided in the embodiments of FIGS. 12-16, for control of fluids in pouch 1400, or other actuators, servos, or the like may be provided.

Several other components of instrument 810 are also connected to compressed gas source 895. A magnet 850, which is mounted on a second side 814 of support member 802, is illustratively deployed and retracted using gas from compressed gas source 895 via hose 878, although other methods of moving magnet 850 are known in the art. Magnet 850 sits in recess 851 in support member 802. It is understood that recess 851 can be a passageway through support member 802, so that magnet 850 can contact blister 546 of pouch 510. However, depending on the material of support member 802, it is understood that recess 851 need not extend all the way through support member 802, as long as when magnet 850 is deployed, magnet 850 is close enough to provide a sufficient magnetic field at blister 546, and when magnet 850 is fully retracted, magnet 850 does not significantly affect any magnetic beads 533 present in blister 546. While reference is made to retracting magnet 850, it is understood that an electromagnet may be used and the electromagnet may be activated and inactivated by controlling flow of electricity through the electromagnet. Thus, while this specification discusses withdrawing or retracting the magnet, it is understood that these terms are broad enough to incorporate other ways of withdrawing the magnetic field. It is understood that the pneumatic connections may be pneumatic hoses or pneumatic air manifolds, thus reducing the number of hoses or valves required.

The various pneumatic pistons 868 of pneumatic piston array 869 are also connected to compressed gas source 895 via hoses 878. While only two hoses 878 are shown connecting pneumatic pistons 868 to compressed gas source 895, it is understood that each of the pneumatic pistons 868 are connected to compressed gas source 895. Twelve pneumatic pistons 868 are shown.

A pair of temperature control elements are mounted on a second side 814 of support 802. As used herein, the term “temperature control element” refers to a device that adds heat to or removes heat from a sample. Illustrative examples of a temperature control element include, but are not limited to, heaters, coolers, Peltier devices, resistance heaters, induction heaters, electromagnetic heaters, thin film heaters, printed element heaters, positive temperature coefficient heaters, and combinations thereof. A temperature control element may include multiple heaters, coolers, Peltiers, etc. In one aspect, a given temperature control element may include more than one type of heater or cooler. For instance, an illustrative example of a temperature control element may include a Peltier device with a separate resistive heater applied to the top and/or the bottom face of the Peltier. While the term “heater” is used throughout the specification, it is understood that other temperature control elements may be used to adjust the temperature of the sample.

As discussed above, first-stage heater 886 may be positioned to heat and cool the contents of blister 564 or blisters 548 and 564 for first-stage PCR. As seen in FIG. 2, second-stage heater 888 may be positioned to heat and cool the contents of second-stage blisters 582 of array 581 of pouch 510, for second-stage PCR. It is understood, however, that these heaters could also be used for other heating purposes, and that other heaters may be included, as appropriate for the particular application.

As discussed above, while Peltier devices, which thermocycle between two or more temperatures, are effective for PCR, it may be desirable in some embodiments to maintain heaters at a constant temperature. Illustratively, this can be used to reduce run time, by eliminating time needed to transition the heater temperature beyond the time needed to transition the sample temperature. Also, such an arrangement can improve the electrical efficiency of the system as it is only necessary to thermally cycle the smaller sample and sample vessel, not the much larger (more thermal mass) Peltier devices. For instance, an instrument may include multiple heaters (i.e., two or more) at temperatures set for, for example, annealing, elongation, denaturation that are positioned relative to the pouch to accomplish thermal cycling. Two heaters may be sufficient for many applications. In various embodiments, the heaters can be moved, the pouch can be moved, or fluids can be moved relative to the heaters to accomplish thermal cycling. Illustratively, the heaters may be arranged linearly, in a circular arrangement, or the like. Types of suitable heaters have been discussed above, with reference to first-stage PCR.

When fluorescent detection is desired, an optical array 890 may be provided. As shown in FIG. 2, optical array 890 includes a light source 898, illustratively a filtered LED light source, filtered white light, or laser illumination, and a camera 896. Camera 896 illustratively has a plurality of photodetectors each corresponding to a second-stage well 582 in pouch 510. Alternatively, camera 896 may take images that contain all of the second-stage wells 582, and the image may be divided into separate fields corresponding to each of the second-stage wells 582. Depending on the configuration, optical array 890 may be stationary, or optical array 890 may be placed on movers attached to one or more motors and moved to obtain signals from each individual second-stage well 582. It is understood that other arrangements are possible. The embodiment for second-stage heaters shown in FIG. 18 provides the heaters on the opposite side of pouch 510 from that shown in FIG. 2. Such orientation is illustrative only and may be determined by spatial constraints within the instrument. Provided that second-stage reaction zone 580 is provided in an optically transparent material, photodetectors and heaters may be on either side of array 581.

As shown, a computer 894 controls valves 899 of compressed air source 895, and thus controls all of the pneumatics of instrument 800. In addition, many of the pneumatic systems in the instrument may be replaced with mechanical actuators, pressure applying means, and the like in other embodiments. Computer 894 also controls heaters 886 and 888, and optical array 890. Each of these components is connected electrically, illustratively via cables 891, although other physical or wireless connections are within the scope of this invention. It is understood that computer 894 may be housed within instrument 800 or may be external to instrument 800. Further, computer 894 may include built-in circuit boards that control some or all of the components, and may also include an external computer, such as a desktop or laptop PC, to receive and display data from the optical array. An interface, illustratively a keyboard interface, may be provided including keys for inputting information and variables such as temperatures, cycle times, etc. Illustratively, a display 892 is also provided. Display 892 may be an LED, LCD, or other such display, for example.

Other prior art instruments teach PCR within a sealed flexible container. See, e.g., U.S. Pat. Nos. 6,645,758, 6,780,617, and 9,586,208, herein incorporated by reference. However, including the cell lysis within the sealed PCR vessel can improve ease of use and safety, particularly if the sample to be tested may contain a biohazard. In the embodiments illustrated herein, the waste from cell lysis, as well as that from all other steps, remains within the sealed pouch. Still, it is understood that the pouch contents could be removed for further testing.

As discussed above, FIG. 2 shows an illustrative instrument 800 that could be used with pouch 510. Instrument 800 includes a support member 802 that could form a wall of a casing or be mounted within a casing. Instrument 800 may also include a second support member (not shown) that is optionally movable with respect to support member 802, to allow insertion and withdrawal of pouch 510. Illustratively, a lid may cover pouch 510 once pouch 510 has been inserted into instrument 800. In another embodiment, both support members may be fixed, with pouch 510 held into place by other mechanical means or by pneumatic pressure.

In the illustrative example, heaters 886 and 888 are mounted on support member 802. However, it is understood that this arrangement is illustrative only and that other arrangements are possible. Illustrative heaters include Peltiers and other block heaters, resistance heaters, electromagnetic heaters, and thin film heaters, as are known in the art, to thermocycle the contents of blister 864 and second-stage reaction zone 580. Bladder plate 810, with bladders 822, 844, 846, 848, 864, 866, hard seals 838, 843, 852, 853, and seals 871, 872, 873, 874 form bladder assembly 808, which may illustratively be mounted on a moveable support structure that may be moved toward pouch 510, such that the pneumatic actuators are placed in contact with pouch 510. When pouch 510 is inserted into instrument 800 and the movable support member is moved toward support member 802, the various blisters of pouch 510 are in a position adjacent to the various bladders of bladder assembly 810 and the various seals of assembly 808, such that activation of the pneumatic actuators may force liquid from one or more of the blisters of pouch 510 or may form pinch valves with one or more channels of pouch 510. The relationship between the blisters and channels of pouch 510 and the bladders and seals of assembly 808 is illustrated in more detail in FIG. 3.

While the pressure transducer 880 (e.g., a window bladder) discussed above in relation to FIG. 3 is one example of a device that may be able to at least partially seal the fluid in the reaction of wells 582 or high-density reaction zone 580 during a reaction, it may be desirable in some cases to form a permanent or semi-permanent seal that can maintain the integrity of the fluid contents of reaction wells for hours, days, or weeks after a reaction is complete—e.g., after a reaction container is removed from an instrument. It is noted that forming a more durable seal that persists after the reaction container is used also can have the effect of better sealing the fluid contents in the reaction wells during the reaction. This invention provides reaction containers, methods, and systems for in-situ sealing of individual reaction wells in a closed reaction container using the conditions already present in the normal reaction to form the seal. For example, the heat and pressure present in some thermocycling reactions can be used to deform a sealing material to form a seal in-situ to seal one or more reaction wells in a reaction container and create a seal that effectively seals the wells during the reaction and that remains after thermocycling is complete and the reaction container is removed from the instrument. Further, illustrative sealable reaction containers, methods, and systems do not risk premature adhesion and sealing prior to the reaction. Likewise, because the conditions needed for seal formation are already present in normal reaction conditions, the containers, methods, and systems described herein do not require any extra steps or handling for seal formation. Reaction wells sealed according to the methods and systems described herein can be preserved and re-read on the same or a different instrument. Such reaction wells can be used for measuring well-to-well variability or instrument-to-instrument variability. Also, reaction wells sealed according to the methods and systems described herein can be used for making a standard (e.g., a fluorescence standard) that can be used for calibrating instruments. Because the sealing material is included with the reaction container and there is little risk of premature seal formation, use of the sealable reaction containers and the methods and systems described herein does not require any special handling or sample preparation on the part of a user.

Turning now to FIGS. 5A and 5B, a cross-sectional view of an embodiment of a reaction container 5000 for performing a plurality of reactions on a fluid sample in a closed system is illustrated. While reaction container 5000 shows several reaction wells 5035 in parallel, this is merely illustrative. The in-situ sealing system described herein may be used for in-situ sealing of any portion of a reaction container, such as, but not limited to, one reaction well or multiple reaction wells in parallel, reaction chambers (e.g., reaction blisters), fluid flow channels, or the like. As illustrated in FIG. 5A, the reaction container 5000 is shown in an initial, undeformed/unsealed state 5000a. FIG. 5B illustrates reaction container 5000 in a deformed/sealed state 5000b.

Reaction container 5000 includes a first outer layer 5010, a second outer layer 5020, an array layer 5030, and a plurality of reaction wells 5035 formed as a series of voids or holes formed in the array layer 5030. In embodiments employing pressure, the material(s) used to form one or more layers of the reaction container 5000 is illustratively flexible enough to allow the pressure to have the desired effect. However, only certain regions of the reaction container 5000 need to be flexible, even in embodiments employing pneumatic pressure. Further, only one side of the reaction container 5000 needs to be flexible, as long as selection portions (e.g., over at least one side of the array layer 5030) are readily deformable. Other regions of the reaction container 5000 may be made of a rigid material or may be reinforced with a rigid material. Thus, it is understood that when the terms “flexible pouch” or “flexible reaction container” or the like are used, only portions of the pouch or reaction container need be flexible. Materials for fabricating the first outer layer 5010, the second outer layer 5020, and the array layer 5030 were discussed in detail herein above in reference to pouch 510 and array 581. Non-limiting examples of materials that may be used include, but are not limited to, polyester, polyethylene terephthalate (PET), polycarbonate, polypropylene (PP), or polymethylmethacrylate. In the illustrated embodiment, the flexible outer layer 5020 is bonded to one end 5053 of the array layer 5030 to seal one end of the wells 5035. Second outer layer 5020 may be bonded directly to the array layer 5030 (e.g., by heat welding or ultrasonic welding) or layer 5020 may include an adhesive layer (e.g., a pressure sensitive adhesive or a heat-activated adhesive) (not shown) that can bond layer 5020 to the array layer 5030.

In the illustrated embodiment, reaction container 5000 includes a sealing layer 5040, wherein 5040a refers to layer 5040 prior to deformation and sealing and 5040b refers to layer 5040 subsequent to deformation and sealing. The sealing layer 5040 is coupled to an inner surface 5047 of the first outer layer 5010 so that the sealing layer 5040 is positioned adjacent to the open end of the array wells 5035. In the initial, undeformed/unsealed state 5000a of the reaction container 5000, the first flexible outer layer 5010 and the sealing layer 5040a are spaced apart from the array layer 5035 and fluid can flow into (or out of) the open ends 5055 of the plurality of wells 5035. Once the fluid sample has filled the wells 5035, pressure may be applied to the outside surface 5049 of layer 5010 to press layers 5010 and 5040 into contact with the second end 5051 of the array layer 5030 to create a temporary seal over the open ends 5055 of the plurality of wells (not shown).

FIG. 5B indicates what may happen under reaction conditions (e.g., during a thermocycling reaction) when, for example, one or both of heat and pressure may be applied. In the illustrated embodiment, the reaction conditions cause a seal to form to seal the open ends 5055 of wells 5035. With layers 5010 and 5040 pressed against the array layer 5030, heat may, for example, be applied to the reaction container 5000 adjacent to layer 5020 to promote a reaction (e.g., a nucleic acid amplification reaction) in plurality of wells 5035 while pressure is being applied adjacent to layer 5010 at surface 5049. In other embodiments, heat and pressure may be applied to the same side of reaction container 5000. Illustratively, the heat and pressure provided to promote the reaction can cause the sealing layer 5040 to deform (as illustratively represented at 5040b) to form an in-situ seal without the need for additional heat or pressure. The deformed sealing layer 5040b may deform around the second end 5051 of the array layer 5030 (example deformations are illustratively shown at 5042 and 5044) and be pressed into the well openings 5055 to create a sealing plug (e.g., shown at 5044) that enters the open ends 5055 of the wells 5035 so that the fluid contents of the wells cannot flow out and intermix during or after the reaction. When the reaction is finished and the heat and pressure are removed, a seal (e.g., a permanent or semi-permanent seal) that seals the open ends 5055 of the individual wells 5035 is left along the second end 5051 of the array layer 5030 at the interfaces between the second ends 5051 and the sealing layer 5040 at 5042/5044.

In one embodiment, the sealing layer 5040 may be applied directly to the inner surface 5047 of outer layer 5010, or the sealing material 5040 may be included as a layer or part of a separate film layer that is bonded to the inner surface 5047 of outer layer 5010 adjacent to the second end of the array layer 5030. For instance, the sealing layer 5040, which illustratively may comprise an adhesive, a swelling material that swells in an aqueous environment, a wax, or the like, may be applied as a continuous layer, as a sprayed coating, or the like directly to the inner surface 5047 of outer layer 5010. In another embodiment, the sealing material 5040 may be coated onto or may be a part of another film layer that can be bonded to the inner surface 5047 of outer layer 5010 adjacent to the second end 5051 of the array layer 5030. The film layer may include a backing layer (e.g., a PET layer) and a sealing material applied to the backing. In one embodiment, such a film layer may be directly bonded (e.g., by heat welding, laser welding, or the like) to the upper flexible layer 5010. In another embodiment, such a film layer may include a second adhesive layer (e.g., a pressure-sensitive adhesive) that is also applied to the backing layer that adheres the film layer to the upper flexible layer.

Examples of suitable heat- and pressure-activated adhesives include, but are not limited to, ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethanes (TPU), polycaprolactone, silicone rubbers, thermoplastic elastomers, waxes (e.g., a microcrystalline wax), polyethylene, polypropylene, low-density polypropylene, co-polymers thereof, and combinations thereof. Suitable heat- and pressure-activated adhesives, waxes, and the like may soften or partially or fully melt under thermocycling conditions to deform into and substantially seal the reaction wells 5035 of the array layer 5030. The melting temperature of the adhesive should be below the maximum temperature of the reaction and above ambient temperature. In one embodiment, an adhesive is used that has a melting point in the range of about 60° C. to about 100° C. (e.g., about 65-95° C., about 70-90° C., about 75-85° C., or about 80-85° C.). One will appreciate, however, that there is an interplay between pressure and heat and that the recited temperature ranges are merely illustrative. For example, if the pressure is relatively increased, less heat may be needed to deform the adhesive to form a seal, or, on the other hand, if pressure is relatively reduced, more heat may be needed to form a seal. When the heat and pressure are removed from the reaction container 5000, the adhesive will resolidify to form a seal that seals the individual wells 5035.

Heat and pressure are not the only in-situ reaction parameters or processes that can be used for well sealing. Other in-situ processes that could produce a permanent seal include, but are not limited to: a liquid sensitive adhesive layer that seals the wells when the reaction liquid is provided to the wells, the wells may be provided with an adhesive catalyst, solvent, or reagent that reacts with the adhesive layer upon well filling, a hygroscopic material may be provided surrounding the micro-well opening that can expand in the presence of water and plug the opening, or a hygroscopic material may be provided in the wells and could be used to absorb the sample as it enters (e.g., like a sponge), preventing the sample components from leaving.

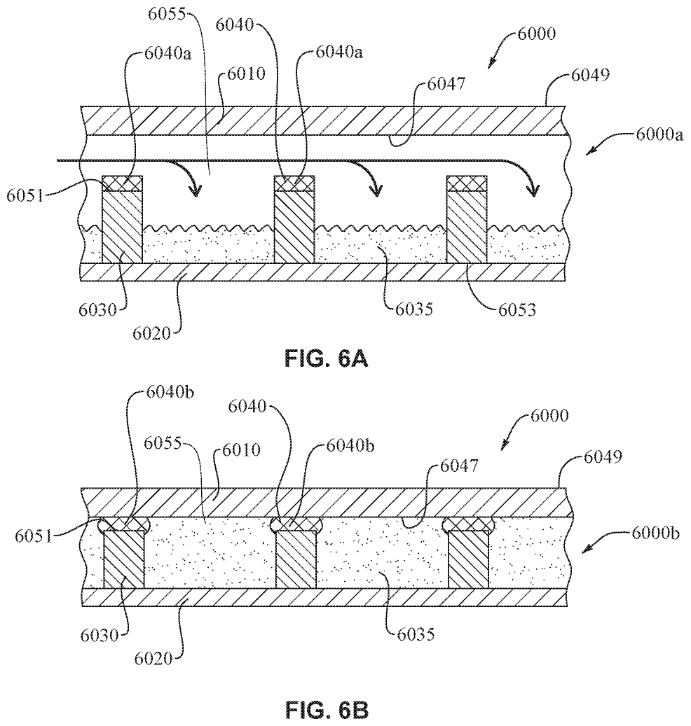

Referring now to FIGS. 6A and 6B, a cross-sectional view of another embodiment of a high-density reaction zone 6000 that is configured for in-situ sealing is shown. The embodiment of FIGS. 6A and 6B is similar to the embodiment illustrated in FIGS. 5A and 5B, except an in-situ sealing material 6040 is disposed on an end 6051 of the high-density array layer 6030 adjacent to the open end 6055 of the wells 6035. As in the previous example, 6040 refers to the sealing material generally, 6040a refers to the sealing material in an initial, undeformed/unsealed state, and 6040b refers to the sealing material in a deformed/sealed state. As illustrated in FIG. 6A, the reaction container 6000 is shown in an initial, undeformed/unsealed state 6000a. FIG. 6B illustrates reaction container 6000 in a deformed/sealed state 6000b.

Reaction container 6000 includes a first outer layer 6010, a second outer layer 6020, an array layer 6030, and a plurality of reaction wells 6035 formed as a series of voids or holes formed in the array layer 6030. Materials for fabricating the first outer layer 6010, the second outer layer 6020, and the array layer 6030 are discussed in detail elsewhere herein. In the illustrated embodiment, the second outer layer 6020 is bonded to a first end 6053 of the array layer 6030 to seal a first end of the wells 6035. Second outer layer 6020 may be bonded directly to the second end 6053 of the array layer 6030 (e.g., by heat welding or ultrasonic welding) or layer 6020 may include an adhesive layer (e.g., a pressure sensitive adhesive or a heat-activated adhesive) (not shown) that can bond layer 6020 to the array layer 6030.

In the illustrated embodiment, reaction container 6000 includes a sealing material 6040 disposed on a second end 6051 of the array layer 6030 opposite the first end 6053. In the initial, undeformed/unsealed state 6000a of the reaction container 6000, the sealing material 6040 is in the unsealed state 6040a and the first flexible outer layer 6010 is separate from the sealing material 6040 such that fluid can flow into (or out of) the open ends 6055 of the plurality of wells 6035. Once the fluid sample has filled the wells 6035, pressure may be applied to the outside of layer 6010 at surface 6049 to press layer 6010 into contact with the sealing material 6040 to create a temporary seal between the inner surface 6047 of layer 6010 and sealing material 6040 that caps off the open ends 6055 of the wells 6035.

With layer 6010 pressed onto sealing material 6040, heat may, for example, be applied to the reaction container 6000 adjacent to layer 6020 to promote a reaction (e.g., a nucleic acid amplification reaction) in plurality of wells 6035. As illustrated in FIG. 6B, the heat and pressure provided to promote the reaction can cause the sealing material 6040 to change from its initial state 6040a to a deformed/sealed state 6040b to form an in-situ seal so that the fluid contents of the wells 6035 cannot flow out of the open ends 6055 of the wells 6035 and intermix during or after the reaction. In one illustrative example, the sealing material 6040 may be a thermoset polymer or a thermoplastic polymer. When the reaction is finished and the heat and pressure are removed, a seal (e.g., a permanent or semi-permanent seal) that seals the individual wells 6035 is left along the interfaces between layer 6010 and the deformed sealing material 6040b.

In one embodiment, the sealing material 6040 may be applied directly to the second end 6051 of the array layer 6030. For instance, the sealing material 6040 may be an adhesive, a swelling agent that swells in an aqueous environment, a wax, or the like that is applied directly to the second end 6051 of the array layer 6030 so that it is disposed adjacent to the inner surface 6047 of outer layer 6010. For instance, as discussed in detail herein above, the array layer may be made from a relatively thick card material that has holes formed therein to form the array of sample wells. For example, the array layer material has a thickness of about 0.3 to about 1 mm (e.g., about 0.4 mm), as compared to about 0.02 to about 0.1 mm for the thickness of the outer layers. In an example embodiment, a sealing material (e.g., a temperature sensitive adhesive) may be applied to the card layer in a continuous coating, as droplets, grid lines, or the like. Then well holes may be formed in the card layer, leaving an array layer with the wells holes bordered by sealing material. In another embodiment, sealing material may be applied after forming the array layer and the well holes.

In yet another embodiment, the sealing material 6040 may comprise a film material that may be bonded to the array layer 6030. The film material may include a backing layer (e.g., a PET layer) and a sealing material as disclosed herein applied to the backing layer. In one embodiment, such a film material may be directly bonded (e.g., by heat welding, laser welding, or the like) to the second end 6051 of the array layer 6030. In another embodiment, such a film layer may include a second adhesive layer (e.g., a pressure-sensitive adhesive) that can adhere the film layer to the second end 6051 of the array layer 6030. Well holes may be formed in the array layer 6030 before or after applying the film material to the array layer 6030. If the film material is applied to the array prior to forming holes in the array, the holes may be formed through the array card, the film, and the in-situ sealing adhesive. If the sealing material is applied to the array as a film carrying an adhesive layer after the array well holes are formed, corresponding holes may be formed in the film/adhesive prior to affixing the film to the array.

Examples of suitable heat- and pressure-activated adhesives (e.g., ethylene-vinyl acetate (EVA), ethylene-ethyl acetate (EEA)) were discussed above in reference to FIGS. 5A and 5B. Suitable heat- and pressure-activated adhesives, waxes, and the like may at least partially melt under reaction conditions (e.g., thermocycling conditions) to substantially seal the reaction wells 6035 of the array layer 6030. In one embodiment, the heat- and pressure-activated adhesive has a melting point in the range of about 60° C. to about 100° C. When the heat and pressure are removed from the reaction container 6000, the heat- and pressure activated adhesive will resolidify to form a seal that seals the individual wells 6035 along the interface between inner surface 6047 of layer 6010 and the sealing material 6040.

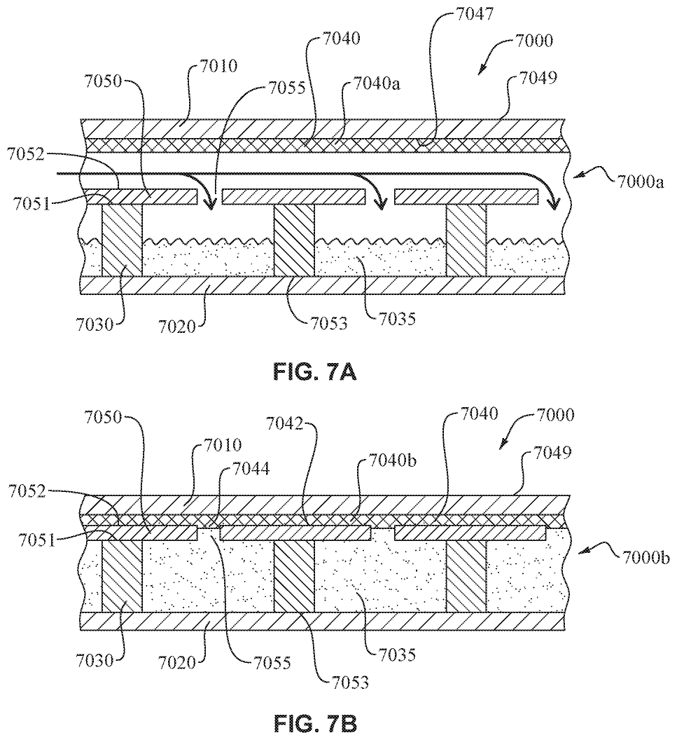

Referring now to FIGS. 7A and 7B, a cross-sectional view of yet another embodiment of a reaction container 7000 that is configured for in-situ sealing is shown. The embodiment of FIGS. 7A and 7B is similar to the high-density reaction zones of the reaction containers shown in the foregoing examples. As in the previous examples, 7040 refers to the sealing material generally, 7040a refers to the sealing material in an initial, undeformed/unsealed state, and 7040b refers to the sealing material in a deformed/sealed state. As illustrated in FIG. 7A, the reaction container 7000 is shown in an initial, undeformed/unsealed state 7000a. FIG. 7B illustrates reaction container 7000 in a deformed/sealed state 7000b.

Reaction container 7000 includes a first outer layer 7010, a second outer layer 7020, an array layer 7030, and a plurality of reaction wells 7035 formed as a series of voids or holes formed in the array layer 7030. Materials for fabricating the first outer layer 7010, the second outer layer 7020, and the array layer 7030 were discussed in detail herein. In the illustrated embodiment, the second outer layer 7020 is bonded to a first end 7053 of the array layer 7030 to seal a first end of the wells 7035. Second outer layer 7020 may be bonded directly to the first end 7053 of the array layer 7030 (e.g., by heat welding or ultrasonic welding) or layer 7020 may include an adhesive layer (e.g., a pressure sensitive adhesive or a heat-activated adhesive) (not shown) that can bond layer 7020 to the array layer 7030. In the illustrated embodiment, reaction container 7000 includes a sealing layer 7040 coupled to an inner surface 7047 of the first outer layer 7010. This sealing layer 7040 is similar to the sealing layer 5040 illustrated in FIGS. 5A and 5B.

FIGS. 7A and 7B show an illustrative embodiment of reaction container 7000 that includes a physical barrier over the opening of array wells 7035. Sandwiched between the first outer layer 7010, sealing layer 7040, and the second outer layer 7020 of reaction container 7000 is the array layer 7030, with wells 7035. Disposed on the second end 7051 of array layer 7030 is pierced layer 7050, provided to act as the physical barrier, with piercings 7055 that allow fluid sample to flow into the wells 7035 in the presence of a force (e.g., a partial vacuum in the wells 7035) but that impede flow back out of the wells in the absence of the force. Illustratively, pierced layer 7050 is a plastic film layer that has been sealed to the second end 7051 of the array layer 7030, illustratively by heat sealing, although it is understood that other methods of fixing may be employed. It is also understood that the material used for the array layer 7030 and the material used for pierced layer 7050 and second outer layer 7020 should be compatible with each other, with the sealing method, and with the chemistry being used.

In the initial, undeformed/unsealed state 7000a (FIG. 7A), the first outer layer 7010 and the sealing layer 7040 are separate from the pierced layer 7050 and the array layer 7035 and, as a result, fluid can flow into (or out of) the plurality of wells 7035 via openings 7055. Illustrative ways of filling a high density array (e.g., array wells 7035) in a closed system without cross-contamination are discussed in U.S. Pat. No. 8,895,295, already incorporated by reference. In the illustrative embodiment shown in FIGS. 7A and 7B the pierced layer 7050 is provided, which is similar to pierced layer 585 of U.S. Pat. No. 8,895,295. Pierced layer 7050 allows fluid to pass into each well 7035 in the presence of a force, but the piercings are small enough to substantially prevent fluid from passing into or out of the wells in the absence of the force. For example, a predetermined amount of vacuum in wells 7035 may be sufficient to draw a fluid through the openings 7055 of the pierced layer 7050 and into the wells; once the predetermined vacuum is ‘consumed’ in filling the wells, fluid will typically not readily flow into or out of the wells 7035 through openings 7055. After filling the array wells 7035, the wells 7035 in array layer 7030 may be temporarily sealed by applying pressure to the first outer layer 7010 adjacent to surface 7049, as discussed, for example, in U.S. Pat. No. 8,895,295, to press the first outer layer 7010 and the sealing layer 7040 against the upper surface 7052 of the pierced layer 7050.

With layer 7040 pressed against the upper surface 7052 of the pierced layer 7050 by application of pressure adjacent to layer 7010 to form a temporary seal, heat may be applied to the reaction container 7000 (e.g., adjacent to layer 7020) to promote a reaction (e.g., a nucleic acid amplification reaction) in plurality of wells 7035. As illustrated in FIG. 7B, the heat and pressure provided to promote the reaction can cause the sealing layer 7040 in the initial, undeformed/unsealed state 7040a to deform, as represented at 7040b, to create a seal so that the fluid contents of the wells 7035 cannot flow out via openings 7055 and intermix during or after the reaction. In the illustrated embodiment, sealing layer 7040 may deform in the sealed state 7040b to at least partially fill into the pierced layer holes 7055 to form sealing plugs 7044. Sealing layer 7040 may further seal as shown, for example, at 7042 at the interface between the upper surface 7052 of the pierced layer 7050 and sealing layer 7040b. When the reaction is finished and the heat and pressure are removed, a seal (e.g., a permanent or a semi-permanent seal) that seals the individual wells 7035 is left along the interfaces between pierced layer 7050, the openings 7055, and the deformed sealing material 7040b.

As was described in detail in reference to FIGS. 5A and 5B, the sealing layer 7040 may be applied directly to the inner surface 7047 of outer layer 7010, or the sealing material 7040 may be included with a separate film layer that is bonded to the inner surface 7047 of outer layer 7010 such that the sealing material 7040 is disposed adjacent to the pierced layer 7050. A sealing layer 7040 applied directly to the inner surface of outer layer 7010 may, for example, be sprayed on or coated on to the inner surface of outer layer 7010. A film layer carrying a sealing material 7040 may be directly bonded (e.g., by heat welding, laser welding, or the like) to the inner surface 7047 of the outer layer 7010, or such a film layer may include a second adhesive layer (e.g., a pressure-sensitive adhesive) that adheres the backing layer adjacent to layer 7010 with the adhesive layer 7040 adjacent to pierced layer 7050.

In various embodiments, the sealing layer 7040 may include an adhesive, a swelling material that swells in an aqueous environment, a wax (e.g., a microcrystalline wax), or the like, and combinations thereof. Typical swelling agents include hydrophilic crosslinked polymers, which swell from 10 to 1,000 times their own weight in an aqueous medium. Examples of suitable heat- and pressure-activated adhesives (e.g., ethylene-vinyl acetate (EVA), ethylene-ethyl acetate (EEA)) were discussed above in reference to FIGS. 5A and 5B. Suitable heat- and pressure-activated adhesives, waxes, and the like at least partially soften or melt under reaction conditions (e.g., thermocycling conditions) to adhere to the pierced layer 7050 and, preferably, deform into the pierced layer holes 7055 to substantially seal the reaction wells 7035 of the array layer 7030. In one embodiment, the heat- and/or pressure-activated adhesive has a melting point in the range of about 60° C. to about 100° C.

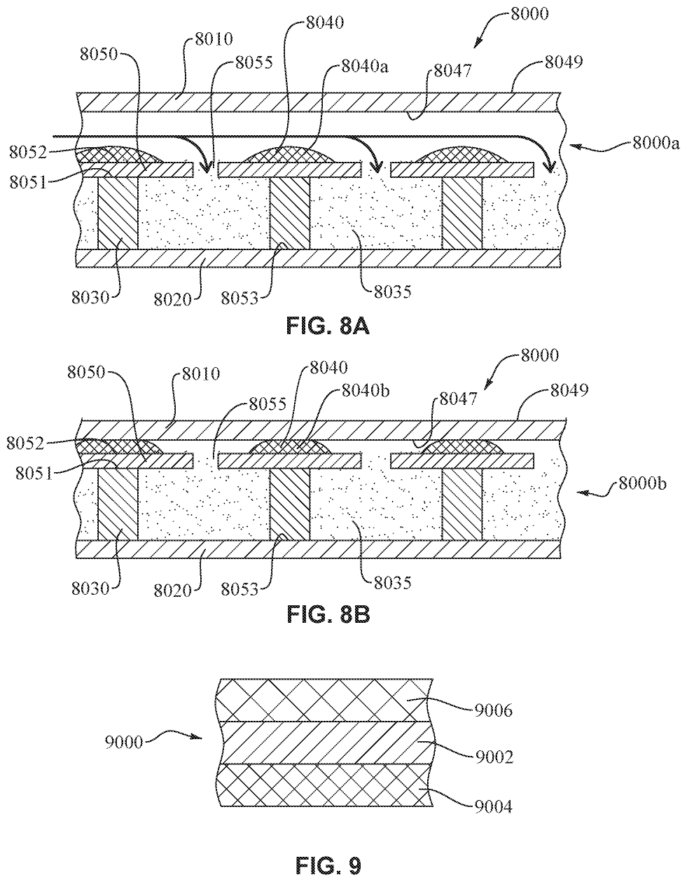

The embodiment of FIGS. 8A and 8B is similar to the embodiment of FIGS. 6A and 6B and 7A and 7B, except the in-situ sealing material 8040 is disposed on the pierced layer 8050 between holes 8055 instead of being disposed directly on the array layer (see, e.g., sealing material 6040 of FIG. 6A disposed on end 6051). As in the previous examples, 8040 refers to the sealing material generally, 8040a refers to the sealing material in an initial, undeformed/unsealed state, and 8040b refers to the sealing material in a deformed/sealed state. As illustrated in FIG. 8A, the reaction container 8000 is shown in an initial, undeformed/unsealed state 8000a. FIG. 8B illustrates reaction container 8000 in a deformed/sealed state 8000b.

Reaction container 8000 includes a first outer layer 8010, a second outer layer 8020, an array layer 8030, a plurality of reaction wells 8035 formed as a series of voids or holes in the array layer 8030, and a pierced layer 8050. Materials for fabricating the first outer layer 8010, the second outer layer 8020, the pierced layer 8050, and the array layer 8030 were discussed in detail elsewhere herein. In the illustrated embodiment, the second outer layer 8020 is bonded to a first end 8053 of the array layer 8030 to seal a first end of the wells 8035. Second outer layer 8020 may be bonded directly to first end 8053 of the array layer 8030 (e.g., by heat welding or ultrasonic welding) or layer 8020 may include an adhesive layer (e.g., a pressure sensitive adhesive or a heat-activated adhesive) (not shown) that can bond layer 8020 to the first end 8053 of the array layer 8030. Likewise, the pierced layer 8050 may be bonded to the second end 8051 of the array layer 8030 opposite the first end 8053 to partially seal the second end of the wells 8035. The pierced layer 8050 may be formed from a film layer that may be bonded directly to the second end 8051 of the array layer 8030 (e.g., by heat welding or ultrasonic welding) or pierced layer 8050 may be formed from a film layer that includes an adhesive layer (e.g., a pressure sensitive adhesive or a heat-activated adhesive) (not shown) that can bond the pierced layer 8050 to the second end 8051 of the array layer 8030.

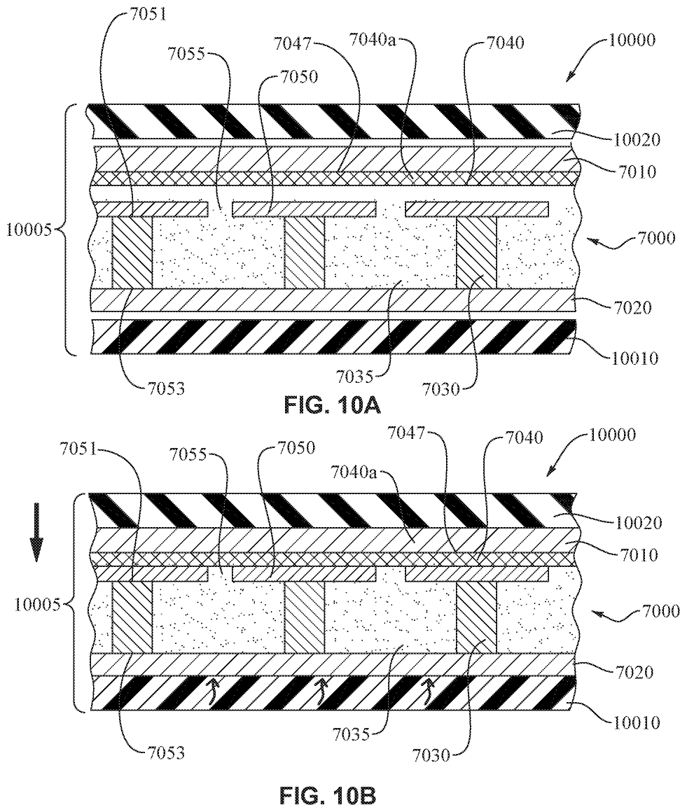

In the illustrated embodiment, reaction container 8000 includes a sealing material 8040 disposed on an upper surface 8052 of the pierced layer 8050 such that the sealing material 8040 is adjacent to the inner surface 8047 of outer layer 8010. In the illustrated embodiment, the sealing material 8040 appears to be discrete droplets or beads of sealing material applied to the pierced layer 8050 adjacent to the holes 8055, but this is merely illustrative. The sealing material 8040 may be applied as a continuous layer atop the pierced layer 8050 or, as will be discussed in greater detail in reference to FIG. 9, the sealing material 8040 may be part of a film material that is applied to the pierced layer 8050 or, alternatively, the pierced layer 8050 may be fabricated from a film that has an in-situ sealing material on one side. With the sealing material 8040 in an initial, undeformed/unsealed state 8040a shown in FIG. 8A, the first outer layer 8010 is separate from the sealing material 8040 and fluid can flow through holes 8055 of the pierced layer 8050 into the plurality of wells 8035. Once the fluid sample has filled the wells 8035, pressure may be applied adjacent to the outer surface 8049 of outer layer 8010 to press layer 8010 into contact with the sealing material 8040 to create a temporary seal. When heat and/or pressure are applied (e.g., in a thermocycling reaction), the sealing material may deform and adhere the inner surface 8047 of outer layer 8010 to the sealing material 8040 in the sealed state 8040b to form a more permanent seal.

In one embodiment, the sealing material 8040 may be applied directly to the upper surface 8052 of the pierced layer 8050. For instance, the sealing material 8040 may be an adhesive, a swelling agent, a wax, or the like, or combinations thereof that is applied directly to the upper surface 8052 of the pierced layer 8050 so that the sealing material is adjacent to the inner surface of outer layer 8010. In an example embodiment, a sealing material (e.g., a temperature sensitive adhesive) may be applied to the pierced layer material as a continuous coating, as droplets, grid lines, or the like and then the piercings may be formed, leaving a pierced layer 8050 with holes 8055 bordered by sealing material 8040. In another embodiment, sealing material 8040 (e.g., droplets or grid lines) may be applied after bonding the pierced layer 8050 to the array layer 8030. In yet another embodiment, the sealing material 8040 may be part of a film layer that is applied to the pierced layer 8050. In such an embodiment, the film layer that includes the sealing material may include holes that are approximately the same size and that substantially correspond to the holes 8055 in the pierced layer 8050 or, alternatively, the sealing material layer may include holes that are substantially larger than the holes 8055 in the pierced layer 8050. Such a film layer may be directly bonded (e.g., by heat welding, laser welding, or the like) to the pierced layer 8050. In another embodiment, such a film layer may include a second adhesive layer (e.g., a pressure-sensitive adhesive) that can adhere the film layer carrying the sealing material to the pierced layer 8050.

In another example, the pierced layer in the embodiment of FIGS. 8A and 8B may be made from a film-based material that includes a sealing layer. An example of a such a film-based material 9000 is illustrated schematically in FIG. 9. Film 9000 includes a backing layer 9002 (e.g., a PET layer) and a first adhesive layer 9004 and a second adhesive layer 9006. A pierced layer similar to 8050 may be prepared by making piercings similar to piercings 8055 in film 9000 and then adhering the pierced film to an array like array 8030. In various embodiments, the first adhesive layer 9004 and the second adhesive layer 9006 may be the same adhesive or they may be different adhesives. For instance, the first adhesive layer 9004 may be an adhesive (e.g., a pressure-sensitive adhesive, a radiation activated adhesive (e.g., an ultraviolet catalyzed epoxy resin), a regular epoxy resin, a surface activated silicone, a cyanoacrylate, a ketone, latex, an anaerobic adhesive, or an acrylate adhesive) selected for bonding the film 9000 to the array, preferably without heat, and the second adhesive layer 9006 may be a sealing layer (e.g., a temperature-sensitive adhesive) that can form an in-situ seal under reaction conditions (e.g., heat and pressure) to form a permanent or semi-permanent seal between adhesive layer 9006 of the pierced layer and an inner surface of an outer layer of a reaction container. In one embodiment, the adhesive for the second adhesive layer 9006 may be selected from the group consisting of, but not limited to, a heat- and/or pressure-activated adhesive, a swelling material that swells in an aqueous environment, a wax, a water-activated adhesive, and combinations thereof. In one embodiment, film material 9000 may be directly bonded (e.g., by heat welding, laser welding, or the like) to and array layer. In another embodiment, such a film layer may include a second adhesive layer (e.g., a pressure-sensitive adhesive or a temperature-sensitive adhesive) that can adhere the film 9000 to an array.

One will also appreciate that a film such as film material 9000 may be used for making the sealing material applied to the outer layer in the embodiments illustrated in FIGS. 5A, 5B, 7A, and 7B. For instance, the first adhesive layer 9004 may be an adhesive (e.g., a pressure-sensitive adhesive) selected for bonding the film 9000 to the outer layer (e.g., to surface 7047 of outer layer 7010 of FIGS. 7A and 7B), preferably without heat, and the second adhesive layer 9006 may be a sealing layer (e.g., a temperature-sensitive adhesive) that can form an in-situ seal under selected reaction conditions (e.g., heat and/or pressure). The first adhesive layer 9004 may be selected to bond film 9000 to the inner surface of the first layer adjacent to the array layer or the pierced layer, depending on the embodiment, and the second adhesive layer 9006 may be selected to form a permanent or semi-permanent seal between adhesive layer 9006 and the second end of the array layer (FIGS. 5A and 5B) or between the adhesive layer 9006 and the pierced layer (FIGS. 7A and 7B) under reaction conditions.

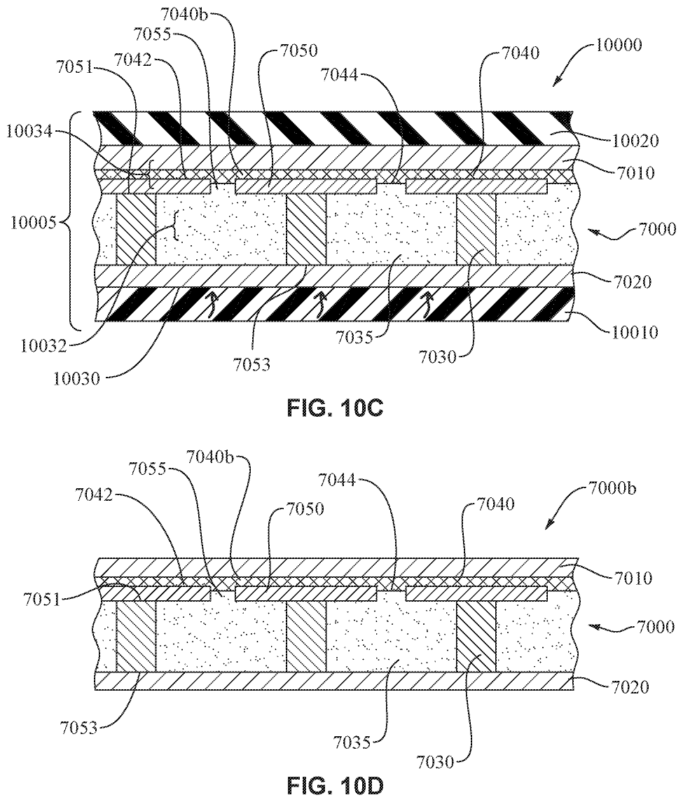

Referring now to FIGS. 10A-10C, a cross-sectional view of a system 10000 is illustrated. FIGS. 10A-10C illustrate an example of how an in-situ seal may be formed in an instrument 10005 with a reaction container that includes a high-density reaction zone and an in-situ sealing feature. FIG. 10D illustrates a high-density reaction zone similar to what is illustrated in FIGS. 7A and 7B after the in-situ seal has been formed in the instrument of FIGS. 10A-10C. While the reaction container shown with system 10000 is the reaction container shown in FIGS. 7A and 7B, one will appreciate that this is for illustrative purposes only and that any of the reaction containers illustrated herein may be received in instrument 10005.

Instrument 10005 shown with system 10000 includes an opening between a heater 10010 and a pressure transducer 10020 configured to receive a reaction container that includes a high-density reaction zone and an in-situ sealing feature. Instrument 10005 shown in FIGS. 10A-10C is only a portion of an instrument and it will be appreciated that the heater 10010 and pressure transducer 10020 may be included in an instrument, such as instrument 800 of FIG. 2, that performs a number of functions, or the heater 10010 and pressure transducer 10020 may be part of a stand-alone instrument that is configured for applying pressure and heat (e.g., for thermal cycling for nucleic acid amplification) to a reaction container.

Reaction container 7000 includes a first outer layer 7010, a second outer layer 7020, an array layer 7030, and a plurality of reaction wells 7035 formed as a series of voids or holes formed in the array layer 7030. In the illustrated embodiment, the second outer layer 7020 is bonded to a first end 7053 of the array layer 7030 to seal a first end of the wells 7035. A second, opposite end 7051 of the array layer includes a pierced layer 7050 over the opening of array wells 7035 to act as the physical barrier, with piercings 7055 that allow fluid sample to flow into the wells 7035 but that may help impede flow back out of the wells. Reaction container 7000 also includes a sealing layer 7040 coupled to an inner surface 7047 of the first outer layer 7010. In the illustrated embodiment, the sealing layer 7040 can deform in response to heat and pressure to form a seal (e.g., a semi-permanent seal) that seals the openings of the reaction wells during a reaction and that remains after the heat and pressure are removed. In the illustrated embodiment, 7040 refers to the sealing layer generally, 7040a refers to the sealing layer in an undeformed/unsealed state, and 7040b refers to the sealing layer in a deformed/sealed state.

In an initial step shown in FIG. 10A, the reaction container 7000 may be disposed between the heater 10010 and the pressure transducer 10020. In the initial step, the heater 10010 and the pressure transducer 10020 may not yet be activated and the sealing layer 7040a and the first outer layer 7010 may not be pressed into contact with the pierced layer 7050, which allows wells 7035 to be filled with fluid. Suitable examples of heaters for heater 10010 may include, but are not limited to, Peltiers and other block heaters, resistance heaters, electromagnetic heaters, and thin film heaters, as are known in the art. Pressure transducer 10020 may be mechanically or pneumatically actuated, as described in detail herein above with reference to pressure transducer 880 of FIG. 3. Where fluorescent excitation of and detection from the contents of wells 7035 is desired, pressure transducer may be a clear plastic bladder or the like that may be inflated over the reaction container after the wells 7035 are filled with a reaction mixture.

In FIG. 10B, the pressure transducer 10020 and heater 10010 are activated. In the illustrated embodiment, actuation of the pressure transducer 10020 has the effect of pressing the second outer layer 7020 of the reaction container 7000 against the heater 10010 to facilitate heat transfer from the heater 10010 to the fluid in the reaction wells 7035. Likewise, actuation of the pressure transducer 10020 can compress the layers 7010 and 7040 against the pierced layer 7050 to seal the wells 7035 shut and to clear excess fluid from the high-density reaction zone. In the illustrated embodiment, actuation of the heater 10010 and/or the pressure transducer 10020 has the effect of transforming the sealing material layer 7040 to form a seal that can seal the reaction wells.

This seal is illustrated in FIG. 10C. In this case, under heat and/or pressure, sealing layer 7040 is deformed from the initial state 7040a to the sealed state 7040b to adhere to pierced layer 7050 at 7042 and to plug the holes 7055 in the pierced layer 7050 at 7044. Reaction container 7000 may experience a first temperature (T₀) at the interface between the heater 10010 and the second outer layer 7020 indicated at 10030, a second, intermediate temperature (Tᵢ) indicated at 10032, and a third temperature (Tₛ) indicated at 10034. In one illustrative example, T₀ may be about 95-105° C. (e.g., about 96° C.), Tᵢ may be about 95-100° C. (e.g., about 95° C.), and Tₛ may be in a range of about 60° C. to about 100° C. (e.g., about 65-95° C., about 70-90° C., about 75-85° C., or about 80-85° C.). In one embodiment, heater 10010 may be configured for an isothermal reaction and temperatures present at T₀, T₁, and Tₛ may be substantially static under reaction conditions. In another embodiment, heater 10010 may be configured for thermocycling and the temperatures present at T₀, Tᵢ, and Tₛ may not be static but may be highest when heater 10010 is at a high temperature portion of the thermal cycle (e.g., denaturation) and lower when heater 10010 is at a lower temperature portion of the thermal cycle (e.g., annealing). In one embodiment, the sealing material of the sealing layer 7040 may be chosen so that is deforms under heat and/or pressure at Tₛ to form a seal that seals the reaction wells 7035. For example, the sealing material may be a heat- and pressure-activated adhesive that has a has a softening point or melting point in the range of about 60° C. to about 100° C. (e.g., about 65-95° C., about 70-90° C., about 75-85° C., or about 80-85° C.). However, the sealing material may be swelling agent that swells in an aqueous environment, a wax, or the like that is activated by heat and/or pressure (e.g., by water vapor) to form a seal that seals the reaction wells 7035.

As illustrated in FIG. 10D, when the heat and pressure are removed from the reaction container 7000 (e.g., when the reaction container is removed from instrument 10005), the sealing material 7040b will resolidify to form a seal that seals the individual wells 7035. Reaction wells sealed according to the methods and systems described herein can be preserved for a time for later confirmation of results and/or for further analysis or re-reading on a different instrument. Such reaction wells can be used for measuring well-to-well variability or instrument variability for different instruments. Also, reaction wells sealed according to the methods and systems described herein can be used for making a standard (e.g., a fluorescence standard) that can be used for calibrating instruments. Because the sealing material forms a seal in-situ, the seal may augment the effect of the pierced layer to further prevent fluid from passing into or out, of the wells while the reaction is proceeding to substantially prevent intermixing of the contents of individual reaction wells with the contents of other reaction wells.

### Example

The following Example is intended to illustrate embodiments of the invention and is not intended to limit the scope of the description or the appended claims.

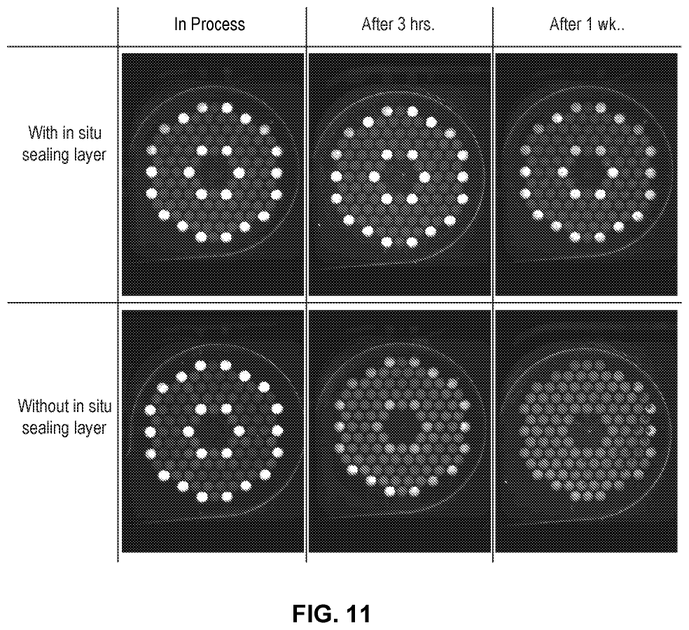

FIG. 11 illustrates time course experiment at several time points (in-process, 1 week, 3 weeks) for retention of a fluorescent material in the wells of high-density reaction zone with and without an in-situ sealing material. FIG. 11 shows the effectiveness of sealing in-situ to adequately isolate individual wells during and after the reaction process. In the illustrated example, a pattern of fluorescent dye was spotted in a micro-well array for arrays with and without an in-situ sealing layer. Examples of arrays of wells with associated material for forming an in-situ seal are illustrated in FIGS. 5A-8B (e.g., FIGS. 7A and 7B). Both arrays showed adequate temporary sealing during the reaction phase (In Process column). However, when the arrays were examined at later time points (after 3 hours and after 1 week), the array without the in-situ sealing layer demonstrated significant mixing of the fluorescent dye from the original wells to adjacent wells. In contrast, the array with the in-situ sealing layer demonstrated good sealing with substantial retention of the fluorescent dye in the original wells and little evidence of dye leakage to adjacent wells.

In this Example, a film material having an ethylene-vinyl acetate (EVA) in-situ sealing material layer applied thereto was placed on an inner surface of the outer layer adjacent to the open end of the array wells in an arrangement similar to the embodiment shown in FIGS. 7A and 7B. While EVA was used as an in-situ sealing material in this example other materials such as, but not limited to, ethylene-ethyl acetate (EEA), ethylene-methyl acetate (EMA), ethylene n-butyl acrylate (EnBA), ethylene-acrylic acid (EAA), thermoplastic polyurethanes (TPU), polycaprolactone, silicone rubbers, thermoplastic elastomers, waxes (e.g., a microcrystalline wax), polyethylene, polypropylene, low-density polypropylene, co-polymers thereof, and combinations thereof could have also been used. Suitable heat- and pressure-activated adhesives, waxes, and the like typically have a softening point or melting point in the range of about 60° C. to about 100° C. (e.g., about 65-95° C., about 70-90° C., about 75-85° C., or about 80-85° C.). As was illustrated in reference to FIG. 10C, the temperature range experienced by the in-situ sealing material is typically in this range during a reaction (e.g., a thermocycling reaction

Heat and pressure are not the only in-situ reaction components that can be used for well sealing. Other in-situ processes that could produce a permanent seal include, but are not limited to: the liquid that fills the wells can activate a liquid sensitive adhesive layer to seal the well, the micro-wells can be filled with an adhesive catalyst, solvent, or reagent that reacts with the adhesive layer upon well filling, or a hygroscopic material surrounding the micro-well opening can expand in the presence of water and plug the opening.

The limitations recited in the claims are to be interpreted broadly based on the language employed in the claims and not limited to specific examples described in the foregoing detailed description, which examples are to be construed as non-exclusive and non-exhaustive. All changes which come within the meaning and range of equivalency of the claims are to be embraced within their scope.

It will also be appreciated that various features of certain embodiments can be compatible with, combined with, included in, and/or incorporated into other embodiments of the present disclosure. For instance, systems, methods, and/or products according to certain embodiments of the present disclosure may include, incorporate, or otherwise comprise features described in other embodiments disclosed and/or described herein. Thus, disclosure of certain features relative to a specific embodiment of the present disclosure should not be construed as limiting application or inclusion of said features to the specific embodiment. In addition, unless a feature is described as being requiring in a particular embodiment, features described in the various embodiments can be optional and may not be included in other embodiments of the present disclosure. Moreover, unless a feature is described as requiring another feature in combination therewith, any feature herein may be combined with any other feature of a same or different embodiment disclosed herein.

We claim:

1. A method for in-situ sealing of a fluid sample in a plurality of reaction wells, comprising:
providing a reaction container comprising an array having a plurality of reaction wells, wherein the array is provided between a lower layer and an upper layer, the lower layer being bonded to a first end of the array to seal a first end of the reaction wells, and a second end of the array or an inner surface of the upper layer being provided with a sealing material for in-situ sealing of a second end of the reaction wells,
introducing a fluid sample into the reaction container such that each of the plurality of reaction wells is filled with a portion of the fluid sample, and
exposing the array to a reaction condition including heat and/or pressure to cause the sealing material to seal the second end of the reaction wells in-situ to substantially prevent flow of the fluid sample out of the plurality of reaction wells during or after exposure to the reaction condition.

2. The method of claim 1, wherein exposing the array to the reaction condition includes applying heat or pressure to the array, and wherein the reaction condition comprises substantially applying only heat or pressure to the array and no additional heat or pressure need be added in-situ to seal the second end of the reaction wells with the sealing material.

3. The method of claim 1, wherein exposing the array to the reaction condition includes applying both heat and pressure to the array.

4. The method of claim 1, wherein exposing the array to the reaction condition includes exposing the array to thermocycling conditions.

5. The method of claim 4, wherein exposing the array to thermocycling conditions includes applying heat adjacent to the lower layer and applying pressure adjacent to the upper layer.

6. The method of claim 1, wherein the upper layer is a flexible film layer that can be pressed against the array to seal a portion of the sample in each of the plurality of reaction wells.

7. The method of claim 6, wherein the sealing material comprises a film layer bonded to the inner surface of the upper layer adjacent to the second end of the reaction wells,
the film layer including a sealing material selected from the group consisting of a heat- and pressure-activated adhesive, a swelling material that swells in an aqueous environment, a wax, and combinations thereof, and
the method further comprising bonding the sealing material under the reaction condition to seal each of the plurality of reaction wells.

8. The method of claim 7, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

9. The method of claim 8, wherein the heat- and pressure-activated adhesive has a melting point in the range of about 60° C. to about 100° C. and exposing the array to the reaction condition includes deforming the sealing material, and wherein deforming the sealing material includes softening or at least partially melting the heat- and pressure-activated adhesive in-situ under thermocycling conditions to deform the heat- and pres sure-activated adhesive into an opening of the plurality of reaction wells.

10. The method of claim 1, wherein the array further comprises a pierced layer bonded to the second end of the array adjacent to the upper layer, the pierced layer having one or more piercings per reaction well, wherein the one or more piercings per reaction well allow the fluid sample to pass into each of the plurality of reaction wells but impede flow of the fluid sample back out of the reaction wells.

11. The method of claim 10, wherein the pierced layer further comprises a sealing material selected from the group consisting of a heat- and pressure-activated adhesive, a swelling material that swells in an aqueous environment, an oil, a wax, and combinations thereof, and wherein the sealing material of the pierced layer deforms in-situ under the thermocycling conditions to seal each of the plurality of reaction wells.

12. The method of claim 11, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

13. The method of claim 1, wherein the array is provided in a closed reaction container that further includes:
a sample injection port for introducing the sample into the container,
a cell lysis zone configured for lysing cells, viruses, or spores located in the sample, the cell lysis zone fluidly connected to the sample injection port, a nucleic acid preparation zone fluidly connected to the cell lysis zone, the nucleic acid preparation zone configured for purifying nucleic acids, and
a first-stage reaction zone fluidly connected to the nucleic acid preparation zone and the array, the first-stage reaction zone comprising a first-stage reaction blister configured for first-stage amplification of the sample,
wherein the cell lysis zone, the nucleic acid preparation zone, and the first stage reaction zone are all provided within the closed reaction container, and the method further comprises steps of:
injecting the fluid sample into the container via the sample injection port, and sealing the sample injection port subsequent to injecting the fluid sample,
introducing the fluid sample into the cell lysis zone and performing a cell lysis in the cell lysis zone to produce a cell lysate,
extracting nucleic acids from the cell lysate, and moving the extracted nucleic acids to the first-stage reaction zone,
subjecting the nucleic acids in the first-stage reaction zone to amplification conditions,
fluidly moving a portion of the nucleic acids from the first-stage reaction zone to each of the plurality of reaction wells of the array, and
performing a second-stage amplification in the plurality of reaction wells of the array.

14. The method of claim 13, wherein the first-stage reaction zone includes a set of primers for PCR amplification of the nucleic acids in the fluid sample, and wherein each of the plurality of reaction wells of the array comprises a pair of primers for PCR amplification of a unique nucleic acid.

15. The method of claim 1, wherein the seal is formed using heat and pressure supplied during or produced by the reaction condition, and wherein formation of the seal does not include a separate heating or pressure step.

16. A container for performing a reaction with a fluid sample in a closed system, the container comprising:
a reaction zone comprising a plurality of layers including an array layer having a plurality of reaction wells formed therein, a first outer layer bonded to a first end of the array layer to seal a first end of the reaction wells, a second outer layer disposed adjacent to a second end of the reaction wells opposite the first end of the reaction wells such that a fluid sample introduced into the reaction zone can flow into each of the reaction wells, and
a sealing layer bonded to the second outer layer disposed adjacent to the second end of the reaction wells or to a second end of the array layer adjacent to the second outer layer, wherein the sealing layer substantially seals the reaction wells in-situ under at least one of heat and pressure to prevent flow of the fluid sample back out of the reaction wells during or after the reaction.

17. The container of claim 16, wherein the sealing layer includes a sealing material selected from the group consisting of a heat- and pressure-activated adhesive, a swelling material that swells in an aqueous environment, a wax, and combinations thereof.

18. The container of claim 17, wherein the heat- and pressure-activated adhesive and/or the wax at least softens and deforms under thermocycling conditions to substantially seal a second end of the reaction wells.

19. The container of claim 18, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

20. The container of claim 19, wherein the heat- and pressure-activated adhesive and/or the wax have a melting point in the range of about 60° C. to about 100° C.

21. The container of claim 16, further comprising a pierced layer bonded to the array layer adjacent to the second outer layer, wherein the pierced layer has one or more piercings per reaction well and the one or more piercings extend through the pierced layer and are large enough to allow the fluid sample to pass into each of the plurality of reaction wells, but small enough to impede flow of the fluid sample back out of the reaction wells.

22. The container of claim 21, wherein the pierced layer further comprises a sealing material selected from the group consisting of a heat- and pressure-activated adhesive, a swelling material that swells in an aqueous environment, an oil, a wax, and combinations thereof.

23. The container of claim 22, wherein the heat- and pressure-activated adhesive is selected from the group consisting of ethylene-vinyl acetate (EVA), ethylene-ethyl acetate (EEA), ethylene-methyl acetate (EMA), ethylene n-butyl acrylate (EnBA), ethylene-acrylic acid (EAA), thermoplastic polyurethane (TPU), polycaprolactone, silicone rubbers, thermoplastic elastomers, waxes, polyethylene, polypropylene, low-density polypropylene, co-polymers thereof, and combinations thereof.

24. The container of claim 16, further comprising
a sample injection port for introducing the sample into the container,
a cell lysis zone configured for lysing cells or spores located in the sample, the cell lysis zone fluidly connected to the sample injection port,
a nucleic acid preparation zone fluidly connected to the cell lysis zone, the nucleic acid preparation zone configured for purifying nucleic acids, and
a first-stage reaction zone fluidly connected to the nucleic acid preparation zone and the reaction zone, the first-stage reaction zone comprising a first-stage reaction blister configured for first-stage amplification of the sample.

25. The container of claim 24, wherein the cell lysis zone, the nucleic acid preparation zone, the first stage reaction zone, and the reaction zone are all provided within the closed system.

26. A thermocycling system, comprising
a sample container for containing a fluid sample to be thermocycled, the sample container including:
a high density reaction zone comprising an array having a plurality of reaction wells, wherein the high density reaction zone is provided in a closed system between an upper layer and a lower layer, the lower layer being bonded to the array to seal one end of the reaction wells, and a sealing material for in-situ sealing of a second end of the reaction wells,
wherein a fluid sample received in the high density reaction zone flows into each of the reaction wells, and
wherein the sealing material deforms under thermocycling conditions to seal the second end of the reaction wells to substantially prevent flow of the fluid sample back out of the reaction wells,
an instrument configured to receive the sample container and subject the sample therein to thermocycling conditions, wherein the instrument includes:
a heater unit for thermocycling the fluid sample in the high density reaction zone between at least a first temperature and a second temperature at a cycle time, the sample container being received in the instrument with the lower layer adjacent to the heater unit,
a pressure transducer for compressing the high density reaction zone adjacent to the upper layer; and
a controller for controlling the heater unit and the pressure transducer.

27. The system of claim 26, wherein the controller includes one or both of an internal computing device or an external computing device.

28. The system of claim 26, wherein the sample container is part of a closed reaction container having at least one additional fluidly connected sample container therein.

29. The system of claim 26, wherein the controller is programmed to perform a method of in-situ sealing of the fluid sample in the plurality of reaction wells, the method comprising:
providing the sample container,
introducing the fluid sample into the high density reaction zone such that each of the plurality of reaction wells is filled with a portion of the fluid sample, and
exposing the array to a reaction condition including heat and/or pressure to cause the sealing material to seal the second end of the reaction wells in-situ to substantially prevent flow of the fluid sample out of the plurality of reaction wells during or after exposure to the reaction condition.
